(19) United States
(12) Patent Application Publication
(10) Pub. No.: US 2024/0300833 A1
(43) Pub. Date: Sep. 12, 2024

(54) ELECTROCHEMICAL CONVERSION TO CARBONATE-CONTAINING COMPOUNDS AND RELATED METHODS

(71) Applicant: Massachusetts Institute of Technology, Cambridge, MA (US)

(72) Inventors: Trevor Alan Hatton, Sudbury, MA (US); Kripa K. Varanasi, Lexington, MA (US); John Lake, Cambridge, MA (US); Seoni Kim, Cambridge, MA (US)

(21) Appl. No.: 18/277,563

(22) PCT Filed: Feb. 17, 2022
(86) PCT No.: PCT/US2022/016793

§ 371 Date: Aug. 16, 2023

Related U.S. Application Data
(60) Provisional application No. 63/150,512, filed on Feb. 17, 2021.

(51) Int. Cl. C02F 1/46; B01D 19/00; C02F 1/20; C02F 1/66; C02F 101/10; C02F 103/08

(52) U.S. Cl. CPC C02F 1/46; B01D 19/0084; C02F 1/20; C02F 1/66; C02F 2101/10; C02F 2103/08

(57) ABSTRACT

Electrochemical conversion of a species into a carbonate-containing compound, or other compounds, from seawater or other aqueous environments is generally described.

### RELATED APPLICATIONS

This application claims the benefit under 35 U.S.C. 119(e) of U.S. Provisional Application Ser. No. 63/150,512, filed Feb. 17, 2021, and entitled “ELECTROCHEMICAL CO₂ REMOVAL,” which is incorporated herein by reference in its entirety for all purposes.

### TECHNICAL FIELD

Electrochemical conversion of a species into a carbonate-containing compound, or other compounds, from seawater or other aqueous environments is generally described.

### BACKGROUND

Carbon dioxide (CO₂) is an important part of our planet's life cycle. It plays an extremely critical role in human and plant respiration and growth. Humans consume O₂ (oxygen) and exhale carbon dioxide (CO₂) as a waste product. In contrast, trees and other plants consume carbon dioxide and release oxygen.

It is important to maintain the proper balance in the amount of CO₂ present in any system, such as Earth's atmosphere and oceans, because CO₂ undergoes chemical reactions with other compounds in ways that can be beneficial or harmful, depending upon that balance.

The ocean absorbs carbon dioxide that is released in the atmosphere. As levels of CO₂ in the atmosphere increase from human activity such as burning fossil fuels (e.g., car emissions) and changing land use (e.g., deforestation), the amount of carbon dioxide absorbed by the ocean also increases.

When CO₂ is absorbed by seawater, a series of chemical reactions occur resulting in the increased concentration of hydrogen ions (H⁺, sometimes referred to as “protons”), which means a decrease in pH (increase in acidity). Carbonate (CO₃²⁻)-containing compounds in the ocean are important for calcification, i.e., to form CaCO₃ and other minerals that are the building blocks of coral reefs and certain shells and other sea life. When pH drops with an increase in H⁺ concentration in the ocean, due to increased CO₂ driven into the ocean from the air above it, the excess H⁺ reacts with, and consumes, some of the carbonate (CO₃²⁻) to form bicarbonate (HCO₃⁻). This consumption of valuable carbonate (CO₃⁻²) degrades the strength and structure of reefs, shells, etc.

### SUMMARY

The invention provides new ways to affect the chemistry in water (aqueous) systems, such as sea water, in a way that can improve sea life.

In one aspect, a system is described comprising a fluid container; an electrode pair configured to convert at least one species in a fluid, when present in the container, to a solid; and a nanotextured surface configured to facilitate nucleation of a solid within the container. In some embodiments, the solid comprises a carbonate-containing compound.

In another aspect, a system is described comprising a first fluid portal associated with a first portion of the flow system and a second fluid portal associated with a second portion of the flow system; a first set of electrodes associated with the first portion of the flow system, configured to alter the pH of water when present in the first portion; a second set of electrodes associated with a second portion of the flow system, configured to alter the pH of water when present in the second portion; a nanotextured surface configured to facilitate nucleation of a solid within the container, wherein the flow system is configured to operate in a first arrangement in which the system draws fluid into the system from the first fluid portal, flows the fluid in a direction from the first portal toward the second portal, through the first portion and the second portion, and ejects the fluid from the second fluid portal, and to be adjustable so as to operate in a second arrangement in which the system draws fluid into the system from the second fluid portal, flows the fluid in a direction from the second portal toward the first portal, through the second portion and the first portion, and ejects the fluid from the first fluid portal.

In another aspect, a system is described comprising a flow system comprising a first orifice constructed to intake an aqueous solution containing bicarbonate; a first electrode associated with a first portion of the flow system, configured to release OH⁻ into the solution and/or to capture H⁺ from the solution to raise the pH of the solution in an amount and under conditions able to cause precipitation of at least some bicarbonate; a second portion comprising a second electrode configured to capture OH⁻ from the solution and/or release H⁺ into the solution thereby lowering the pH of the solution; and a second orifice configured to eject the solution from the flow system.

In another aspect, a method is described comprising intaking an aqueous solution containing bicarbonate through a first orifice into a flow system; in a first portion of the flow system, electrochemically raising the pH of the solution by releasing OH⁻ from a first electrode into the solution, and/or capturing H⁺ from the solution at the first electrode, thereby causing precipitation of at least some bicarbonate; flowing the solution into a second portion of the flow system, and at a second electrode electrochemically lowering the pH of the solution by capturing OH⁻ from the solution at a second electrode and/or releasing H⁺ into the solution from the second electrode; ejecting the solution from the flow system through a second orifice.

In one aspect, systems and methods are provided that in part reverse the production of bicarbonate (HCO₃⁻) from introduction of carbon dioxide (CO₂) into aqueous systems, such as oceans. In one set of embodiments, water, such as seawater, is treated, for example, by being drawn into a system where H⁺ concentration is increased to push the reaction of bicarbonate (HCO₃⁻) back to carbon dioxide (CO₂). Then, carbon dioxide (CO₂) is removed, H⁺ concentration is lowered to levels appropriate for healthy ocean pH, and the water is returned to the ocean.

In another embodiment, water, such as seawater, is drawn into a flow system, the pH is raised, optionally by releasing OH⁻ from a first electrode into the solution or capturing H⁺ from the solution at the first electrode, thereby causing precipitation of at least some bicarbonate ion. The solution is flowed into a second portion of the flow system and, optionally via a second electrode, the pH of the solution is lowered by capturing OH⁻ from the solution or releasing H⁺ into the solution, and the solution is ejected through a second orifice.

The systems can be reversible.

Other aspects and embodiments for summary of the invention are as outlined in the claims.

The subject matter of the present disclosure involves, in some cases, interrelated products, alternative solutions to a particular problem, and/or a plurality of different uses of one or more systems and/or articles.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic diagram of a system configured to capture and/or release carbon dioxide including a gas permeable article, according to some embodiments;

FIG. 1B is a schematic diagram of a system configured to capture and/or release carbon dioxide including a gas permeable article and a textured surface, according to some embodiments;

FIG. 1C is a schematic diagram of a system configured to capture and/or release carbon dioxide including a textured surface, according to some embodiments;

FIG. 1D is a schematic diagram of a system configured to capture and/or release carbon dioxide, according to some embodiments;

FIG. 2 is a schematic diagram showing CO₂ release and water alkalization modulation of proton concentration in feed stream, coupled with facile removal of CO₂ bubbles as they form at aerophilic surfaces, and the process is readily powered by renewable resources, according to some embodiments;

FIG. 3 is a schematic diagram of an interdigitated electrode configuration and an embodiment of electrochemical oceanwater CO₂ removal cell arrangement, using aerophilic surfaces of the gas permeable article to capture generated gas, according to some embodiments;

FIG. 4 shows a schematic diagram illustrating the incorporation of appropriate conductive polymeric materials (e.g., polypyrrole) to prevent this agglomeration and stabilize the electrode performance with less than 10% fade after 100 cycles, according to some embodiments;

FIG. 5 show several diagrams including a phase diagram for whether a bubble, blister, or plastron will be thermodynamically favorable and an example of an easily manufactured “low-phi” surface which promotes plastron formation and maintenance and a series of photographic images showing the capture of a CO₂ bubble into the plastron of a low phi aerophilic surface, according to some embodiments;

FIG. 6 is a schematic of a bench-scale demonstration unit where flows to and from cells 1 and 2 are switched periodically with 3-way solenoid valves, according to some embodiments;

FIG. 7 is a schematic of electrochemically modulated mineralization system for CO₂ that is brine fed to electrochemical cell and alkalized by the release of hydroxyls to favor mineralization to form CaCO₃ with an inset showing details of a electrode configuration with mineralization promoting surfaces and an implementation of the process on a deep sea platform, which, in this case, the mineralized products are returned to the ocean to settle on the ocean bed, and other options are to filter out the carbonate particles to be used as, e.g., construction materials, and electrical energy may be supplied by renewable resources, according to one embodiments;

FIG. 8 shows schematic diagrams of electrochemical systems for seawater alkalization to enable mineralization, according to some embodiments;

FIG. 9 shows schematic diagrams for the mineralization surface concept and a surface schematic illustrating preferential nucleation nanotextured resulting in enhanced nucleation of gypsum, according to some embodiments;

FIG. 10 is a schematic of so-called crystal critters that may self-eject crystals and also illustrating particle-assisted nucleation, according to some embodiments; and

FIG. 11 shows high-throughput microfluidic drop reactors for obtaining nucleation parameters by utilizing AI and machine learning, according to one embodiment.

### DETAILED DESCRIPTION

The following disclosure describes articles, systems, and methods for capturing and/or releasing gas, such as carbon dioxide (CO₂), using electrochemistry. The anthropogenic emissions of carbon dioxide, and other gases (e.g., greenhouse gases), has detrimentally increased the temperature of the Earth, disrupting many global climate patterns, and, hence, there is a need to reduce the amount of these gases in the environment. Much attention has been directed towards removing gas emissions from the atmosphere but a similar drive to reduce carbon dioxide from sources of water, such as oceans and other surface waters, has not yet materialized. In many sources of water, increasing acidification has already led to destruction of coral reefs. However, the concentrations of certain species in water (on a volumetric basis) are much higher than ambient air (compare 100 mg/L in water with 0.77 mg/L in ambient air), and thus smaller volumes will need to be treated compared to the direct atmospheric capture of certain species (e.g., carbon dioxide), which may provide a processing advantage.

The direct air capture of gases like carbon dioxide requires both capture of the molecule by chemical complexation and subsequent breaking of these bonds when the carbon dioxide is recovered as a pure gas. However, advantageously, only the latter step may be needed for CO₂ removal from water, which avoids one of the steps usually required for CO₂ mitigation from gaseous sources.

It has been recognized and discovered as described by this disclosure, that electrochemistry can be used capture and/or release gases from a liquid (e.g., water, whether pure or relatively pure, or containing salts, contaminants, whether organic or inorganic, e.g., seawater). While, of course, water treatment is known, certain of these existing water treatment systems require the use of membranes in order to remove certain chemical species from the water. These membranes often increase processing complexity and cost. In one aspect of this disclosure, the articles, systems, and methods described herein may capture and/or release a gas without the use of any membranes. The approach described herein uses the electrochemical modulation of the pH of a water source to capture and/or release carbon dioxide. A solution containing carbon dioxide (such as seawater) may be passed over one or more sets of electrodes. The electrodes may decrease the amount of H⁺ in solution, resulting in a net decrease in the amount of carbon dioxide in the solution. Subsequently, the treated solution may be acidified (i.e., by increasing an amount of H+ in the solution), resulting in a release carbon dioxide to the solution. This electro-swing approach, in some cases, does not require expensive membranes or the addition of chemicals (e.g., small organic molecules) to the water source. In some cases, the approach is easy to deploy and does not lead to formation of byproducts or secondary streams.

It has been discovered and appreciated by this disclosure that when the chemical species to be removed and/or captured from a liquid (e.g., water) is carbon dioxide, the solution pH can be used to drive the bicarbonate-carbon dioxide equilibrium concentration towards CO₂ release and/or or capture, according to the reaction:

HCO₃⁻+H⁺⇄H₂CO₃⇄CO₂+H₂O

In some embodiments, proton selective electrodes may be used to modulate the proton concentration within the source of water. Some details regarding these electrodes are described in more detail below. For example, under a suitable applied voltage across an electrochemical cell within the water source, the protons and related counterions (e.g., from a counterelectrode) are released, and the solution is acidified, and the CO₂ is removed as a gas (i.e., Le Chatelier's principle's, without wishing to be bound by any particular theory). The remaining (acidic) liquid stream may be introduced to a second electrochemical cell where the potential is reversed and the protons and counterions in water source are absorbed within their respective electrodes, which may now be regenerated for a subsequent separation cycle in which flows-to and polarities-of the cells are switched. This regeneration step may also have the advantage that it may alkalize the treated water source before it is discharged. In some respects, the cell acts like a battery in that energy expended during one phase of the cyclic process and is partially recovered in the other phase of the cyclic process, and the energy loss over a cycle under ideal conditions would simply be the chemical energy for the CO₂ release. Advantageously, this single-stream cyclic approach may avoid the use of membranes and the production of gases, such as hydrogen and/or chlorine, or of acids and bases in separate streams, as occurs in electrodialysis, and does not need the introduction of additional chemical reagents to acidify the water source, nor bases to alkalize the water source (or the treated water source) again. In some cases, the method is free of electrolysis, and may also be free of an anolyte and catholyte, which, by contrast, is common in certain existing system.

In some instances, the net reaction is removal and/or release of CO₂ as a pure stream, and the basification of the treated water, both of which may address environmental concerns, such as the acidification the ocean, without the generation of unwanted side products. In some instances, an electrode configuration may be used within the water source to capture and/or release CO₂ from a source of water. In some embodiments, vacuum may be applied to facilitate release of CO₂ (e.g. a flash tank). In some such instances, an interdigitated electrode configuration may advantageously reduce the inter-electrode distances and thereby overcome possible ion transport and electrical resistances. However, it should be understood that other configurations are possible, and other chemical species other than CO₂ may be removed from a source of water using the articles, systems, and method described herein.

Turning to the figures, specific, non-limiting embodiments are described in further detail. It should be understood, however, that the various systems, components, features, and methods described relative to these embodiments may be used either individually and/or in any desired combination as the disclosure is not limited to only the specific embodiments described herein.

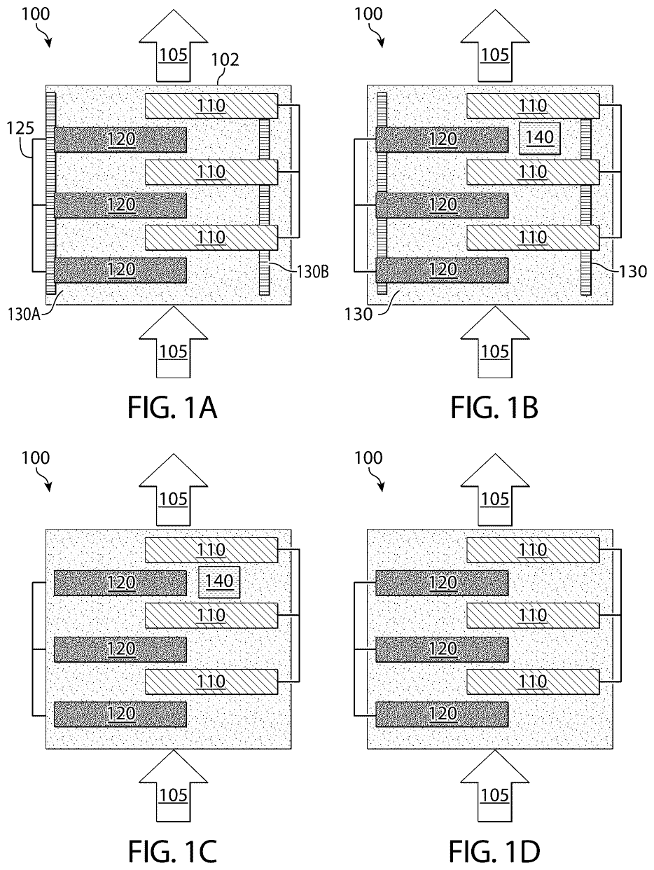

In some embodiments, a system is described (e.g., a fluid treatment system, a flow system) that may capture and/or release a gas. FIG. 1A schematically depicts a system. System 100 of FIG. 1A includes a fluid container 102 that contains a first set of electrodes 110 and a second set of electrodes 120. As shown schematically in the figure, the first set of electrodes 110 and the second set of electrodes are interdigitated. Advantageously, interdigitated electrodes allow for a liquid flowing through the container (e.g., via flow 105) to contact a second electrode of the second set of electrodes after contacting a first electrode of the first set of electrodes, and/or vis versa. Of course, it should be understood that other configurations of electrodes.

In some embodiments, an electrode or a set of electrodes is in electric communication with another electrode (e.g., to another electrode of a set, to another electrode of a different set). For example, in FIG. 1A, a wire 125 electrically connects the electrodes of the second set of electrodes 120. In some embodiments, a set of electrodes is additionally or alternatively attached to another component of the system and/or an external component (not pictured in the figure), such as a potentiostat, a voltmeter, to another system, to a controller configured to operate the system, as non-limiting examples.

Various embodiments may also include a gas permeable article. In some embodiments, the gas permeable article is an article that is not ionically or electronically conductive, and not permeable to a non-gas fluid (e.g., a liquid) when present in the system. In another set of embodiments, the gas permeable article is more permeable to one gas than another gas, i.e., the article favors permeability of one gas as opposed to one or more other gases. In some such embodiments, one or more gases may be excluded from passage while allowing permeable of the one gas. In another set of embodiments gas permeable article may pass several or most gases and inhibit the flow of another fluid such as a liquid. In this set of embodiments, one or more liquids may be somewhat permeable to the article where one or more other liquids may be less permeable. Where the gas permeable article is preferentially permeable to a particular gas or gases than to another set of gas or gases or a liquid or liquids, the permeability of the most permeable gas is at least 25% greater than the permeability of another species. In another set of embodiments the gas that is most permeable is at least 50%, at least 100%, at least 200%, at least 500%, at least 1000%, at least 5000%, or at least 10,000% more permeable than the permeability of one or more of the other species.

For example, FIG. 1A schematically depicts a gas permeable article 130 (e.g., 130A and 130B). The gas permeable article 130 may be configured to capture gas (e.g., carbon dioxide) generated within the system and remove the gas from flow 105 so that the generated gas (e.g., gas bubbles) does not significantly impact (e.g., reduce) the flow of a liquid within the system (and/or into and out of the system). In some embodiments, the gas permeable defining at least one wall of the container and configured to pass a gas from a portion within the container to a gas capture or vent external to the container. For example, in FIG. 1A, the gas permeable article 130A defines a wall of the fluid container 102. However, other positions of the gas permeable article are possible. For example, in FIG. 1A, the gas permeable article 130B is included within the system 100 but does not define a wall of the fluid container 102. Other positions and configurations of gas permeable article are possible.

In some embodiments, a nanotextured surface is present within the system. For example, as illustrated schematically in FIG. 1B, the system 100 includes a nanotextured surface 140. The nanotextured surface may be configured to facilitate nucleation and/or removal of a gas and/or solid species (e.g., nucleation of a solid carbonate-containing species) within the system.

In some embodiments, the system includes both a gas permeable article for removing a gas from the system and a nanostructured surface for nucleating a species (e.g., a solid species, a carbonate-containing species). For example, as shown schematically in FIG. 1B, the system 100 includes a gas permeable article 130 and a nanotextured surface 140. However, in some embodiments, the system includes a nanotextured surface without including a gas permeable article. For example, as illustrated in FIG. 1C, the system 100 includes the nanotextured surface 140 but does not include a gas permeable article. In some embodiments still, the system includes no gas permeable article and no nanotextured surface, as shown schematically in FIG. 1D. Those skilled in the art, in view of the present disclosure, will be capable of selecting the inclusion of a gas permeable article and/or a nanotextured surface. Some factors to consider in this selection are (1) the capture and/or release functionality of the system; (2) the nature or composition of one or more electrodes in the system; and (3) the desired pH of the system, without limitation.

The articles, systems, and methods described herein may include inlets/outlets (e.g., portals, orifices) that can allow egress and/or ingress of fluid (e.g., a liquid, water, seawater). For example, in some embodiments, a first fluid portal is associated with a first portion of the flow system and a second fluid portal is associated with a second portion of the flow system. In some embodiments, a flow system comprises a first orifice constructed to intake an aqueous solution containing bicarbonate. In some embodiments, intaking an aqueous solution containing bicarbonate occurs through a first orifice into a flow system. In some embodiments, a second orifice is configured to eject the solution from the flow system. In some embodiments, intaking an aqueous solution containing bicarbonate occurs through the second orifice into the flow system. These fluid portals or orifices may allow a fluid, such as water, to flow into and out of the system. The articles, system, and methods may also include appropriate tubing, channels, conduits, and the like for conveying a fluid from one portion of the system to another portion of the system. Those skilled in the art, in view of the present disclosure, will be capable of selecting the appropriate inlets, outlets, tubing, channels, conduits, and the like.

As mentioned above, various embodiments comprise a gas permeable article. The gas permeable article can pass a gas within a system (e.g., a portion within a container within a system) to a different portion of the system or to an external vent. For example, the system may include a gas nucleating surface comprising a surface of a gas permeable article and/or a nanotextured surface in a first and/or the second portion of the system. Advantageously, passing the gas from the portion of the system to a different portion or to an external vent may remove gas from the flow path of a fluid within the system, such that the impact on flow of a fluid (e.g., a liquid) within the system is reduced or minimized. In some embodiments, the gas permeable article defines at least one wall of a container (e.g., a fluid container) within the system. However, the gas permeable article is not limited to defining a wall of a container, as other positions and configurations of the gas permeable article are possible. For example, the gas permeable article may be positioned proximate to an electrode (e.g., a first set of electrodes, a second set of electrodes). In some embodiments, the gas permeable article is positioned proximate to a nanotextured surface within the system.

In some embodiments, the gas permeable article comprises an aerophilic material. An aerophilic material is a material that can attract a gas and may subsequently transport the gas. In some embodiments, the gas permeable article comprises a layer of air between two adjacent layers, and the air is configured to remain within the layer when submerged in a liquid. In some embodiments, the gas permeable article may comprise a porous portion (e.g., a porous portion defining at least one wall of the container), and the porous portion may further comprise at least one pore configured to be submerged by a liquid, wherein this one pore is configured to restrict transport of the liquid while transporting a gas within the liquid. Some examples of gas transporting materials are described in U.S. Publication No. US-2020-0338476-A1, published on Oct. 29, 2020, filed as U.S. application Ser. No. 16/955,210, and entitled “BUBBLE GAS HARVESTING AND/OR TRANSPORT METHODS AND ASSOCIATED SYSTEMS AND ARTICLES”, incorporated herein by reference, in its entirety, for all purposes.

In some embodiments, the gas permeable article is porous or comprises a porous portion. In some embodiments, the gas permeable article (or a porous portion of the gas permeable article) has a porosity greater than or equal to 20%, greater than or equal to 25%, greater than or equal to 30%, greater than or equal to 40%, or greater than or equal to 50%. In some embodiments, the porosity of the gas permeable article is less than or equal to 70%, less than or equal to 60%, less than or equal to 50%, less than or equal to 40%, less than or equal to 30%, less than or equal 25%, or less than or equal to 20%. Combinations of the above-referenced ranges are also possible (e.g., greater than or equal to 20% and less than or equal to 40%). Other ranges are possible.

The gas permeable article may be constructed of any suitable material. For example, in some embodiments, the gas permeable article is not ionically and/or electronically conductive, and the material of the gas permeable article may be selected such that the gas permeable article does not conduct one or more ionic species and/or does not conduct electrons. Non-limiting examples of suitable materials for the gas permeable article include polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ε-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly (vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the gas permeable article comprises a cellulosic material (e.g., cellulose fibers, cellulose filter paper). Other materials are possible.

In some embodiments, the gas permeable article is non-ionically conductive. In some of those embodiments, the gas permeable article may have an average ion conductivity (e.g., H⁺ conductivity, Cl⁻ conductivity) of less than or equal to 10⁻⁶ S/cm, less than or equal to 10⁻⁷ S/cm, less than or equal to 10⁻⁸ S/cm, or less than or equal to 10⁻⁹ S/cm. In some embodiments, the gas permeable may have an average ion conductivity of greater than or equal to 10⁻¹⁰ S/cm, greater than or equal to 10⁻⁹ S/cm, greater than or equal to 10⁻⁸ S/cm, greater than or equal to 10⁻⁷ S/cm, or greater than or equal to 10⁻⁶ S/cm. Combinations of the above-referenced ranges are also possible (e.g., an ion conductivity of greater than or equal to 10⁻¹⁰ S/cm and less than or equal to 10⁻⁶ S/cm). Other ranges are possible.

In some embodiments, a gas permeable article may also substantially impede the flow of electrons across the article, e.g., the article has an electronic conductivity of less than or equal to 10⁻¹⁰ S/cm, or another suitable range described herein.

As mentioned above, some embodiments may include a textured surface (e.g., a nanotextured surface). In some embodiments, the textured surface can facilitate nucleation and/or precipitation of species (e.g., nucleation of a gas, nucleation of a solid species, such as carbonate-containing compound). In some embodiments, a nanotextured surface is configured to facilitate nucleation of a solid within a container. Any suitable texturing may be used, and those skilled in the art, in view of the present disclosure, will be capable of selecting appropriate texturing. For example, in some embodiments, the textured surface may have a step-like features to provide texture to the surface. In some embodiments, the textured surface is patterned and/or roughened surface. In some embodiments, the textured surface comprises gratings. In some embodiments, the textured surface comprises an array (e.g., 1-D array, a 2-D array) of features (e.g., wells, protrusions, pores, cavities, pillars, hair- or grass-like features) that provide texture to the surface.

In some embodiments, the textured surface (e.g., a nanotextured surface) comprises features (e.g., adjacent features, an array of features) that are spaced regularly from one another. In some embodiments, the spacing between features of the textured surface is greater than or equal to 100 nm, greater than or equal to 200 nm, greater than or equal to 300 nm, greater than or equal to 400 nm, greater than or equal to 500 nm, greater than or equal to 750 nm, or greater than or equal to 1 micron. In some embodiments, the spacing between features of the textured surface is greater than or equal to 5 microns, greater than or equal to 10 microns, greater than or equal to 25 microns, or greater than or equal to 50 microns. In some embodiments, the spacing between features of the textured surface is less than or equal to 50 microns, less than or equal to 25 microns, less than or equal to 10 microns, or less than or equal to 5 microns. In some embodiments, the spacing between features of the textured surface is less than or equal to 1 micron, less than or equal to 750 nm, less than or equal to 500 nm, less than or equal to 400 nm, less than or equal to 300 nm, less than or equal to 200 nm, or less than or equal to 100 nm. Combinations of the above-referenced ranges are also possible (e.g., greater than or equal to 100 nm and less than or equal to 1 micron). Other ranges are possible.

In some embodiments, the textured surface comprises features (e.g., adjacent features, an array of features) that are spaces regularly from one another. In some embodiments, the spacing between features of the textured surface is greater than or equal to 100 microns, greater than or equal to 250 microns, greater than or equal to 500 microns, greater than or equal to 700 microns, greater than or equal to 750 microns, or greater than or equal to 1000 microns. In some embodiments, the spacing between features of the textured surface is less than or equal to 1000 microns, less than or equal to 750 microns, less than or equal to 700 microns, less than or equal to 700 microns, less than or equal to 500 microns, less than or equal to 250 microns, or less than or equal to 100 microns. Combinations of the above-referenced ranges are also possible (e.g., greater than or equal to 100 microns and less than or equal to 1000 microns). Other ranges are possible.

In some embodiments, the textured surface is a hierarchically textured surface, i.e., comprising both microscale and nanoscale texturing within one or more of the above-reference ranges.

In some embodiments, the textured surface (e.g., nanotextured surface) is textured is a roughened surface. In some embodiments, the textured surface has a RMS surface roughness of greater than or equal to 50 nanometers, greater than or equal to 100 nanometers, greater than or equal to 250 nanometers, greater than or equal to 500 nanometers, greater than or equal to 750 nanometers, greater than or equal to 1 micron, greater than or equal to 10 microns, greater than or equal to 20 microns, greater than or equal to 25 microns, greater than or equal to 50 microns, greater than or equal to 75 microns, or greater than or equal to 100 microns. In some embodiments, the textured surface has a RMS surface roughness of less than or equal to 100 microns, less than or equal to 75 microns, less than or equal to 50 microns, less than or equal to 25 microns, less than or equal to 20 microns, less than or equal to 10 microns, less than or equal to 1 micron, less than or equal to 750 nanometers, less than or equal to 500 nanometers, less than or equal to 250 nanometers, less than or equal to 100 nanometers, or less than or equal to 50 nanometers. Combinations of the above-referenced ranges are also possible (e.g., greater than or equal to 100 nanometers and less than or equal to 100 microns). Other ranges are possible.

In some embodiments, a textured surface (e.g., a nanotextured surface) is configured to eject a precipitate (e.g., a carbonate-containing solid). For example, a solid may be nucleated within a nanotextured surface, leading to growth of the solid within the surface. Upon reaching a particular particle size (e.g., a particular crystal size), the particle may grow out of plane of the nanotextured surface. In some embodiments, the nanotextured surface is configured to eject a precipitate (e.g., a crystalline precipitate). In some such embodiments, ejection may occur continuously; that is to say, the nanotextured surface can be configured to nucleate a precipitate, eject the precipitate once the precipitate reaches a particular size, and subsequently allow new precipitate to form (and subsequently eject). The particle size of the precipitate to achieve ejection can vary and may depend on the sizing and/or spacing of the features of the textured surface. Other factors in selecting an appropriate textured surface include, but are not limited to, (1) reducing or minimizing precipitate formation on electrode surfaces as this can lead to passivation (2) enhancing nucleation and growth rates of the precipitation process to enhance the overall efficiency of the system (3) removal of the precipitate (e.g., carbonate crystals) from the reactor.

The systems and methods described herein may also include one or more electrodes. The electrodes may control aspects of the electrochemistry within a system, and those skilled in the art will be capable of selecting appropriate electrodes in view of this disclosure. For example, in some embodiments, one or more electrode (e.g., a pair of electrodes) is configured to convert at least one species in a fluid, when present in the container, to a gas. In some embodiments, an electrode pair configured to convert at least one species in a fluid, when present in the container, to a solid. In some embodiments, a first electrode associated with a first portion of a flow system is configured to release H+ (i.e., protons, H₃O⁺) into the solution to lower the pH of the solution in an amount and under conditions able to convert at least some bicarbonate to carbon dioxide. In some embodiments, in a first portion of a flow system, an electrode may facilitate electrochemically lowering the pH of a solution, thereby converting at least some bicarbonate to carbon dioxide. In some embodiments, a second portion of the flow system comprises a second electrode configured to capture H⁺ thereby raising the pH of the solution. In some embodiments, an electrode pair is configured to convert at least one species in a fluid, when present in the container, to a solid. Generally, the electrodes are selected to capture and/or release a species (e.g., carbon dioxide) from a liquid (e.g., water, an aqueous solution, seawater). In some embodiments, the electrodes are within a set of electrodes (e.g., a first set of electrodes, a second set of electrodes). In a set of electrodes, each electrode may independently be the same or different in nature or composition. For example, each electrode of a first set of electrodes may be configured to release a certain chemical species (e.g., H⁺, OH⁻), while each electrode in a second set of electrodes may be configured to capture a same or different chemical species (e.g., OH⁻, H⁺). In some embodiments, an electrode (e.g., a counterelectrode) is configured to release a counterion of a chemical species (e.g., Cl⁻ may be the counterion for H⁺, Na⁺ may be the counterion for OH⁻). Those skilled in the art, in view of this disclosure, will be capable of selecting electrodes for capturing and/or release one or more chemical species.

A variety of electrode materials are suitable for a system. For example, in some embodiments, the electrode comprises a protonated manganese oxide compound, such as HMnO₂. In some embodiments, an electrode comprises nickel hexacyanoferrate (NiHCF). In some embodiments, an electrode comprises silver chloride (AgCl). In some embodiments, an electrode comprises bismuth (Bi). Additional non-limiting examples of suitable electrode materials include metal oxides, such titanium oxide, ruthenium oxide, iridium oxide, and/or platinum oxide. Other materials are possible.

An electrode may have any suitable thickness. In some embodiments, an electrode has a thickness of greater than or equal to 100 nm, greater than or equal to 250 nm, greater than or equal to 500 nm, greater than or equal to 750 nm, greater than or equal to 1 micron, greater than or equal to 2 microns, greater than or equal to 3 microns, greater than or equal to 5 microns, greater than or equal to 10 microns, greater than or equal to 20 microns, greater than or equal to 25 microns, or greater than or equal to 50 microns. In some embodiments, an electrode has a thickness of less than or equal to 50 microns, less than or equal to 25 microns, less than or equal to 20 microns, less than or equal to 10 microns, less than or equal or equal to 5 microns, less than or equal to 3 microns, less than or equal to 2 microns, less than or equal to 1 micron, less than or equal to 750 nm, less than or equal to 500 nm, less than or equal to 250 nm, or less than or equal to 100 nm. Combinations of the above-referenced ranges are also possible (e.g., greater than or equal to 100 nm and less than or equal to 10 microns). Other ranges are possible. In embodiments in which more than one electrode is present, each electrode may independently have a thickness in one or more of the ranges described above.

As mentioned above and elsewhere herein, the articles, systems, and methods described herein can facilitate the capture and/or release of a gas. In an exemplary embodiment, the gas comprises carbon dioxide, and carbon dioxide can be captured and/or released from a system. Without wishing to be bound by any particular theory, in embodiments including carbon dioxide, the following equilibrium can be considered:

HCO₃⁻+H⁺⇄H₂CO₃⇄CO₂+H₂O,

where carbon dioxide (i.e., CO₂) can be a gas dissolved in solution (e.g., aqueous solution). However, other gases are possible. Non-limiting examples of other gases that may be captured and/or released include ammonia gas to ammonium (i.e., NH₃⇄NH₄⁺), for example, in water (i.e., NH₄⁺+OH⁻⇄NH₃+H₂O), and other acid gases different from carbon dioxide, such as hydrogen sulfide (H₂S), hydrogen chloride (HCl), hydrogen fluoride (HF), sulfur oxides (e.g., SO₂ and SO₃) and nitrogen oxides.

In some embodiments, a system includes, or a method describes a fluid or liquid from which a species can be captured and/or released. For example, in some embodiments, the fluid or liquid is water. That is to say, in some embodiments, the fluid or liquid is an aqueous solution. In some such embodiments, a gaseous species dissolved in water, such as carbon dioxide, can be captured from the water. In some such embodiments, a solid species may be produced (e.g., precipitated) within the water. However, in some embodiments, carbon dioxide can be released from the water. In an exemplary embodiment, the fluid or liquid is seawater, and a species can be captured and/or released into seawater. For embodiments in which water is the fluid or liquid, the equilibrium of carbon dioxide may result in the production and/or the consumption of species comprising carbonate, bicarbonate, carbonic acid, and/or water.

Various embodiments may include modifying the pH (or providing an electrode configured to modify the pH) of a fluid (e.g., a liquid, water). For example, some embodiments comprise electrochemically lowering the pH of the solution by releasing H+ from a first electrode into the solution in a first portion of a fluid container. In some embodiment, a second electrode captures H+ in a second portion of a fluid container thereby raising the pH of the solution. In some embodiments, a method comprises intaking an aqueous solution containing bicarbonate through a first orifice into a flow system. In some embodiments, a first electrode associated with a first portion of the flow system is configured to release OH⁻ into the solution and/or to capture H⁺ from the solution to raise the pH of the solution in an amount and under conditions able to cause precipitation of at least some bicarbonate. In some embodiments, a method comprises intaking an aqueous solution containing bicarbonate through the second orifice into the flow system. In some embodiments, a method comprises electrochemically raising the pH of the solution by releasing OH⁻ from the second electrode in the second portion of the flow system into the solution and/or capturing H⁺ from the solution at the second electrode, thereby causing precipitation of at least some bicarbonate. In some embodiments, a method comprises flowing the solution into the first portion of the flow system, and at the first electrode electrochemically lowering the pH of the solution by capturing OH⁻ from the solution at the first electrode and/or releasing H⁺ into the solution from the first electrode. In some embodiments, a method comprises lowing the solution into a second portion of the flow system, and, at a second electrode, electrochemically lowering the pH of the solution by capturing OH⁻ from the solution at a second electrode and/or releasing H⁺ into the solution from the second electrode. In some embodiments, a method comprises, in a first portion of the flow system, electrochemically raising the pH of the solution by releasing OH⁻ from a first electrode into the solution, and/or capturing H⁺ from the solution at the first electrode, thereby causing precipitation of at least some bicarbonate. In some embodiments, a method comprises, in the second portion of the flow system, electrochemically lowering the pH of the solution by releasing H⁺ from the second electrode into the input solution, thereby converting at least some bicarbonate to carbon dioxide. In some embodiments, a second electrode is configured to capture OH⁻ from the solution and/or release H⁺ into the solution within the second portion thereby lowering the pH of the solution. In some embodiments, a method comprises flowing the solution into the first portion of the flow system, and at the first electrode capturing H⁺ thereby raising the pH of the solution.

In some embodiments, the pH of a fluid (e.g., a liquid, a solution) is adjusted to an acidic pH. In some embodiments, the pH is adjusted to less than or equal to 6.5, less than or equal to 6, less than or equal to 5.5, less than or equal to 5, less than or equal to 4.5, less than or equal to 4, less than or equal to 3.5, less than or equal to 3.0, less than or equal to 2.5, less than or equal to 2.0, less than or equal to 1.5, or less than or equal to 1.0. In some embodiments, the pH is adjusted to greater than or equal to 1.0, greater than or equal to 1.5, greater than or equal to 2.0, greater than or equal to 2.5, greater than or equal to 3.0, greater than or equal to 3.5, greater than or equal to 4.0, greater than or equal to 4.5, greater than or equal to 5.0, greater than or equal to 5.5, greater than or equal to 6.0, or greater than or equal 6.5. Combinations of the foregoing ranges are also possible (e.g., the pH is adjusted to greater than or equal to 1.0 and less than or equal to 6.5). Other ranges are possible. In some embodiments, lowering the pH comprises lowering the pH from a first pH to a second pH, wherein the second pH is lower than the first pH. In some, embodiments, wherein raising the pH comprises raising the pH from a first pH to a second pH, wherein the second pH is greater than the first pH.

In some embodiments, the pH of a fluid (e.g., a liquid, a solution) is adjusted to a basic pH (i.e., the fluid can be alkalized). In some embodiments, the pH is adjusted to greater than or equal to 7.5, greater than or equal to 8.0, greater than or equal to 8.5, greater than or equal to 9.0, greater than or equal 9.5, greater than or equal to 10.0, greater than or equal to 10.5, greater than or equal to 11.0, greater than or equal to 11.5, greater than or equal to 12.0, or greater than or equal to 12.5. In some embodiments, the pH is adjusted to less than or equal to 12.5, less than or equal to 12.0, less than or equal to 11.5, less than or equal to 11.0, less than or equal to 10.5, less than or equal to 10.0, less than or equal to 9.5, less than or equal to 9.0, less than or equal to 8.5, less than or equal to 8.0, or less than or equal to 7.5. Combinations of the foregoing ranges are also possible (e.g., the pH is adjusted to greater than or equal to 7.5 and less than or equal to 12.5). Other ranges are possible.

It should be noted that various of the systems and methods described herein are reversible. That is to say, in some cases, a system can capture a species (e.g., carbon dioxide) and then subsequently release the species (e.g., under different operating conditions, such as a different applied voltage) or the system can release a species and then subsequently capture the species. By way of illustration (and not limitation), it may be advantageous to capture carbon dioxide from a first source of water and release the captured carbon dioxide to different source of water. In such a scenario, the articles, systems, and methods described herein could be used to capture carbon dioxide within the first source of water to then subsequently release carbon dioxide to the different source of water. In some embodiments, capture and release cycles can occur at least 2 times, at least 3 times, at least 5 times, at least 10 times, at least 100 times, at least 103 times, at least 10⁴, at least 10⁵ times, or at least 10⁶ times. Other ranges are possible. In some embodiments, the system is reversible and configured to intake an aqueous solution containing bicarbonate through the second orifice into the flow system, the second electrode is configured to lower the pH of the solution by releasing H⁺ from the second electrode into the input solution, thereby converting at least some bicarbonate to CO₂, further comprising a gas outlet associated with the second portion configured to vent CO₂ from the solution, the first electrode is configured to capturing H⁺ thereby raising the pH of the solution, and the first orifice is conjured to eject the solution from the flow system.

Various embodiments may include, form, or precipitate a carbonate (i.e., a carbonate containing species). For example, in some embodiments, calcium carbonate (CaCO₃) is precipitated from an aqueous solution. The nature and type of carbonate will depend on the source of water and/or the type(s) of electrode(s) used within a system. In some embodiments, the carbonate is a salt of an alkali metal (e.g., Li₂CO₃, Na₂CO₃, K₂CO₃, Cs₂CO₃). In some embodiments, the carbonate is a salt of an alkaline earth metal (e.g., MgCO₃, CaCO₃, BaCO₃). Other carbonates are possible, as this disclosure is not so limited.

As mentioned above, various embodiments described herein may be used without a membrane separating the sets of electrodes within the electrochemical system. Many existing water treatment systems require a membrane (e.g., reverse osmosis) in order to treat the water. However, various of the systems describes herein may advantageously treat a source of water without the presence of a membrane.

The articles, systems, and methods described herein can be useful in removing carbon dioxide from sea or ocean water, among other applications. In some embodiments, the articles, systems, and can be used as a membrane-free process utilizing electrochemical pH modulation to initially release carbon dioxide and then to re-alkalizing the treated water before it is returned to the ocean. Of course, other applications are possible. For example, the articles, systems, and methods can be useful for water treatment or water softening application for the removal of carbonates from hard water, water heaters, water coolers, cooling towers, and other water feed streams. As another example, the articles, systems and methods can be useful for amine regeneration in post-combustion CO₂ capture, desalination, and/or resource recovery. Other applications are possible.

In some embodiments, a fluid treatment system is described comprising a fluid container; an electrode pair configured to convert at least one species in a fluid, when present in the container, to a gas; a gas capture and removal system, comprising a gas permeable article that is not ionically or electronically conductive, and not permeable to a fluid when present in the system, defining at least one wall of the container and configured to pass a gas from a portion within the container to a gas capture or vent external to the container; and/or a nanotextured surface configured to facilitate nucleation of a gas within the container.

In some embodiments, a flow system is described comprising a first fluid portal associated with a first portion of the flow system and a second fluid portal associated with a second portion of the flow system; a first set of electrodes associated with the first portion of the flow system, configured to alter the pH of water when present in the first portion; a first gas capturing and vent system associated with the first portion configured to capture and vent gas emitted from water when present in the first portion; a second set of electrodes associated with the second portion of the flow system, configured to alter the pH of water when present in the second portion; a second gas capturing and vent system associated with the second portion configured to capture and vent gas emitted from water when present in the second portion, wherein the flow system is configured to operate in a first arrangement in which the system draws fluid into the system from the first fluid portal, flows the fluid in a direction from the first portal toward the second portal, through the first portion and the second portion, and ejects the fluid from the second fluid portal, and to be adjustable so as to operate in a second arrangement in which the system draws fluid into the system from the second fluid portal, flows the fluid in a direction from the second portal toward the first portal, through the second portion and the first portion, and ejects the fluid from the first fluid portal. For some embodiments, the flow system further comprises, in the first and/or the second portion, a gas nucleating surface comprising a surface of a gas permeable article and/or a nanotextured surface.

In some embodiments, a system is described comprising a flow system comprising a first orifice constructed to intake an aqueous solution containing bicarbonate; a first electrode associated with a first portion of the flow system, configured to release H+ into the solution to lower the pH of the solution in an amount and under conditions able to convert at least some bicarbonate to CO: a gas outlet associated with the first portion configured to vent CO₂ from the solution; a second portion of the flow system comprising a second electrode configured to capture H⁺ thereby raising the pH of the solution; a second orifice configured to eject the solution from the flow system. For some embodiments, the system is reversible and configured to intake an aqueous solution containing bicarbonate through the second orifice into the flow system, the second electrode is configured to lower the pH of the solution by releasing H⁺ from the second electrode into the input solution, thereby converting at least some bicarbonate to CO₂, further comprising a gas outlet associated with the second portion configured to vent CO₂ from the solution, the first electrode is configured to capturing H⁺ thereby raising the pH of the solution, and the first orifice is conjured to eject the solution from the flow system.

In some embodiments, a system is described comprising a flow system comprising a first orifice constructed to intake an aqueous solution containing bicarbonate; a first electrode associated with a first portion of the flow system, configured to release OH⁻ into the solution and/or to capture H⁺ from the solution to raise the pH of the solution in an amount and under conditions able to cause precipitation of at least some bicarbonate; a second portion comprising a second electrode configured to capture OH⁻ from the solution and/or release H⁺ into the solution thereby lowering the pH of the solution; and a second orifice configured to eject the solution from the flow system.

In some embodiments, a method is described comprising intaking an aqueous solution containing bicarbonate through a first orifice into a flow system; in a first portion of the flow system, electrochemically lowering the pH of the solution, thereby converting at least some bicarbonate to CO₂; removing at least some of the CO₂ from the solution; flowing the solution into a second portion of the flow system, and raising the pH of the solution; ejecting the solution from the flow system through a second orifice. For some embodiments, the method comprises, in the first portion, electrochemically lowering the pH of the solution by releasing H⁺ from a first electrode into the solution, and in the second portion, at a second electrode capturing H⁺ thereby raising the pH of the solution. For some embodiments, the method further comprises intaking an aqueous solution containing bicarbonate through the second orifice into the flow system; in the second portion of the flow system, electrochemically lowering the pH of the solution by releasing H⁺ from the second electrode into the input solution, thereby converting at least some bicarbonate to CO₂; removing at least some of the CO₂ from the solution; flowing the solution into the first portion of the flow system, and at the first electrode capturing H⁺ thereby raising the pH of the solution; ejecting the solution from the flow system through the first orifice.

In some embodiments, a method is described comprising intaking an aqueous solution containing bicarbonate through a first orifice into a flow system; in a first portion of the flow system, electrochemically raising the pH of the solution by releasing OH⁻ from a first electrode into the solution, and/or capturing H⁺ from the solution at the first electrode, thereby causing precipitation of at least some bicarbonate; flowing the solution into a second portion of the flow system, and at a second electrode electrochemically lowering the pH of the solution by capturing OH⁻ from the solution at a second electrode and/or releasing H⁺ into the solution from the second electrode; ejecting the solution from the flow system through a second orifice. For some embodiments, the method further comprises intaking an aqueous solution containing bicarbonate through the second orifice into the flow system; in the second portion of the flow system, electrochemically raising the pH of the solution by releasing OH⁻ from the second electrode into the solution, and/or capturing H⁺ from the solution at the second electrode, thereby causing precipitation of at least some bicarbonate; flowing the solution into the first portion of the flow system, and at the first electrode electrochemically lowering the pH of the solution by capturing OH⁻ from the solution at the first electrode and/or releasing H⁺ into the solution from the first electrode; ejecting the solution from the flow system through the first orifice.

In some embodiments, at least some CO₂ is removed from the solution, facilitated by nucleating at least some CO₂ at a surface, wherein the surface optionally is a surface of a gas permeable article or is a nanotextured surface.

In some embodiments, the gas permeable materials is water impermeable and is not ionically or electronically conductive.

In some embodiments, the method is free of electrolysis.

In some embodiments, the flow system is essentially free of anolyte and catholyte.

In some embodiments, the solution is seawater.

The following examples are intended to illustrate certain embodiments of the present invention, but do not exemplify the full scope of the invention.

### Example 1

The following description includes examples of fabrication and use of aspects of the invention, some of which are proposed/prophetic.

We provide a new approach based solely on electrochemical modulation of proton concentration within electrochemical cells to initially release the CO₂ in seawater, and then to alkalize the water before it is returned to the ocean. This battery-like electro-swing approach does not require expensive membranes or addition of chemicals, is easy to deploy, and does not lead to formation of byproducts. Innovative electrode configurations are deployed to reduce overall transport and electrical resistances while still enabling large quantities of water to be treated efficiently. Novel aerophilic surfaces provide for the capture and removal of CO₂ bubbles as they form to alleviate their otherwise disruptive impact on the performance of the cells. These advances lead to more compact CO₂ capture processes with promising low energetics. Detailed thermodynamic and transport modeling enable optimization of module design, and techno-economic deployment of the new technology.

Industrial emissions of carbon dioxide and other gases are wreaking havoc on the environment as the continuing accumulation of CO₂ in the atmosphere leads to rising temperatures and disruption of the global climate patterns. While much attention has been focused on strategies for mitigation of the global CO₂ release of almost 40 Gt per year through capture at point sources followed by geologic storage, more recently there has been a surge of interest in negative emissions technologies in which the offending gases (currently at an atmospheric concentration of ˜415 ppm) are removed from the ambient environment itself through approaches such as direct air capture (DAC), bioenergy with carbon capture and sequestration (BECCS), and reforestation.

The focus on atmospheric accumulation has not yet been matched by a similar drive to reduce CO₂ in oceans and other surface waters where increasing acidification has already led to destruction of coral reefs, and reduced carbonate ion concentrations harm shellfish and other marine life. The total amount of CO₂ in the ocean rivals that in the atmosphere, and thus effective techniques for its removal can augment the other negative emissions technologies to reduce the environmental burden imposed by this greenhouse gas. The concentrations in water (on a volumetric basis) are much higher at 100 mg/L than that in the ambient air (0.77 mg/L), and thus smaller volumes will need to be treated than in DAC, which can provide a processing advantage. Moreover, while direct air capture requires both capture of the CO₂ by chemical complexation with a sorbent, and subsequent breaking of these bonds when the CO₂ is recovered as a pure gas, only the latter step is needed for CO₂ removal from surface waters, which avoids one of the steps usually required for CO₂ mitigation from gaseous sources.

Approaches to solving this challenging problem are improved if they do not require the addition of chemicals, nor lead to parasitic reactions with the formation of undesirable compounds. The Office of Naval Research (ONR) has shown that electrodeionization can be one means to address these problems, but the need for ion-exchange membranes makes this an expensive proposition. Here, we provide a new membrane-free approach based solely on electrochemical modulation of the pH to initially release the CO₂ and then to alkalize the treated water before it is returned to the ocean. This electro-swing approach does not require expensive membranes or addition of chemicals, is easy to deploy, and does not lead to formation of byproducts or secondary streams. We provide innovative, flexible electrode configurations that reduce overall transport and electrical resistances while enabling treatment of large quantities of water. Moreover, since the formation of bubbles as the CO₂ is released can be disruptive to the performance of the cells, we provide effective ways to capture and remove the bubbles as they form. These advances lead to more compact CO₂ capture processes.

The CO₂ removal modules can be installed on stationary platforms co-located with wind farms or solar islands in the seas or installed on cargo ships plying the oceans; the captured CO₂ can be injected directly from platforms into sub-surface geologic structures for long term sequestration or used as a feedstock for fuels and commodity and specialty chemicals production. Other arrangements can be provided as well.

In contrast to the growing number of papers addressing the direct capture of CO₂ from ambient air, only a handful of reports have been published on the removal of CO₂ from ocean waters, and these have been based on either classical electrodialysis or an electrodeionization process. The goal of these studies was to use captured CO₂ as a feedstock for production of liquid fuels

Some previous studies used bipolar membrane electrodialysis with compartments separated by ion-exchange membranes to produce two liquid streams; one acidic and one basic. In the low pH stream, conversion of the carbonate and bicarbonate ions released gaseous CO₂ which was removed by vacuum stripping. The two liquid streams were subsequently combined and the now nominally pH-neutral stream was returned to the ocean. The process required the use of H₂SO₄/Na₂SO₄ solutions for the two electrode compartments sandwiching the bipolar membrane stack. In later work, the acidified stream was added to a brine solution to release CO₂ while the basic stream generated in the process was added to brine to drive the formation of carbonate ions, which then precipitated as CaCO₃. In addition to requiring suitable electrolyte solutions for the two electrode compartments, this process relied on generation of three different streams in the electrodialyzer-acid, base and brine.

A previous study described a process wherein protons generated in an anode chamber pass through a cation exchange membrane to a central compartment in which the pH of the feed seawater is reduced to release CO₂, which can be vacuum stripped. The sodium ions displaced by these protons pass through a second cation exchange membrane to report to the cathode chamber, where water splitting occurs to produce hydrogen gas and sodium hydroxide; the NaOH is mixed with the effluent from the center chamber to alkalize the CO₂-depleted feed stream before it is returned to the ocean. Mineral deposits at the high pH cathode surface are re-dissolved on periodic reversal of the cell polarities. The process achieved its stated goal of producing hydrogen gas while simultaneously removing CO₂ from the feed stream; the NaOH produced was then used to basify the treated ocean water. While no chemical reagents were needed, there was a need for deionized water to be introduced to both electrode chambers (about 20% of the flow of seawater), which provided added process complexity and cost.

Another study proposed a combination of electrodialysis for the removal of CO₂ from seawater with catalytic methanol production, both powered by solar energy captured by marine-based islands of photovoltaic cells. The study argued that while there is significant uncertainty in costs, and other factors, this approach can help alleviate the problems associated with fossil fuel usage.

A potential drawback of the technologies developed to date would seem to be the need for expensive anion and cation exchange membranes, the preparation of electrode solutions either via addition of chemical reagents or by reverse osmotic deionization of seawater, and the generation of multiple liquid streams that need to be mixed again before return to the ocean. A technology that does not rely on chemical separation (acid and base) into two streams that need to be remixed, that does not need ion-exchange membranes, and that avoids the need for separate electrode solutions, can be an attractive alternative approach to the oceanwater CO₂ removal. It is the purpose of this proposal to develop such a technology.

### Technology Description

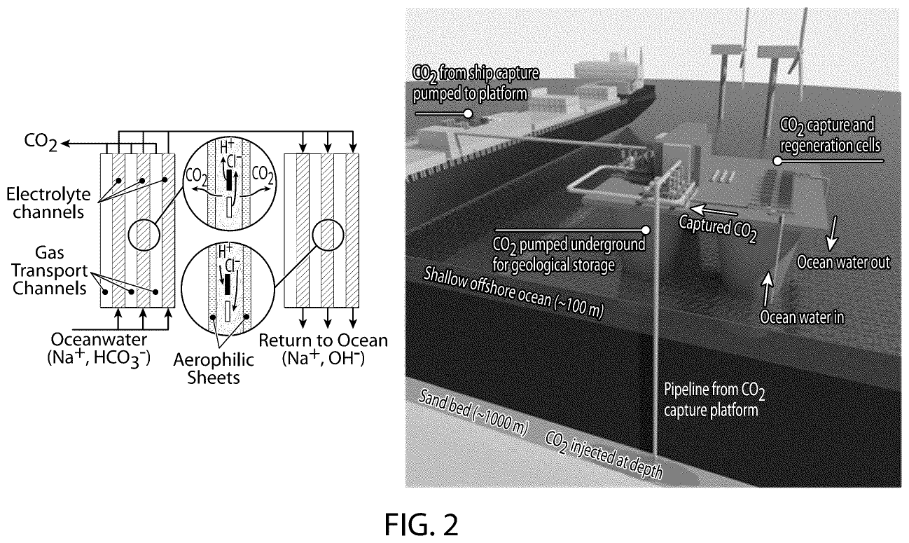

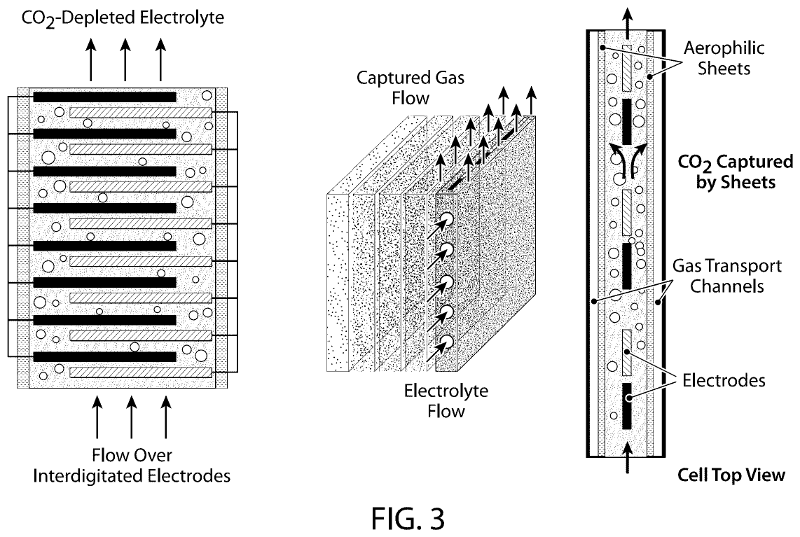

The removal of CO₂ from ocean and surface waters can be attained by decreasing the solution pH to drive the bicarbonate-carbon dioxide equilibrium concentration towards CO₂ release according to the reaction: HCO₃⁻+H⁺⇄H₂CO₃⇄CO₂+H₂O. We use proton selective electrodes to modulate the proton concentration within sea water introduced to an asymmetric electrochemical cell (FIG. 2); such electrodes can an effective way to mediate the capture and release of CO₂ in the promoted potassium carbonate (K₂CO₃) process. Under a suitable applied voltage across the cell, the protons and chloride ions (from the counter electrode) are released, the solution is acidified, and the CO₂ is removed as a gas. The resulting liquid stream is introduced to a second electrochemical cell where the potential is reversed and the protons and chloride ions in solution are absorbed within their respective electrodes, which are now regenerated for the next separation cycle in which flows to and polarities of the cells are switched. This regeneration step also has the advantage that it alkalizes the treated sea water before it is discharged. The cell acts like a battery in that energy expended during one phase of the cyclic process is partially recovered in the other, the energy loss over a cycle under ideal conditions simply being the chemical energy for the CO₂ release. This single-stream cyclic approach avoids the use of membranes and the production of gases, such as hydrogen and/or chlorine, or of acids and bases in separate streams, as occurs in electrodialysis, and does not need the introduction of chemical reagents to acidify the solution, nor bases to alkalize it again. The net reaction is removal of CO₂ as a pure stream, and the basification of the treated water, both of which address the ocean acidification concerns directly, without the generation of unwanted side products. An interdigitated electrode configuration (FIG. 3) may be used to reduce inter-electrode distances and thereby overcome possible ion transport and electrical resistances.

In one set of embodiments, a gas capture and removal system is provided to remove one or more gases that products action either to discard them or two capture and use them in full or in part. any suitable gas capture and removal system can be used in combination with other aspects described here end and some specific gas capture and removal systems are described which can be particularly advantageous one purpose of a gas capture and removal system can be for the suppression of gas bubble formation within a flowing stream, as bubbles can be disruptive to the flow within the channels, and block access of the solution to the active electrodes. Thus, the capture of CO₂ directly from ocean water can involve not only release of the molecular CO₂ into solution, but also effective technique for capturing and transporting it once it is nucleated in its gaseous state. We provide aerophilic surfaces to form plastrons that facilitate CO₂ gas capture and transport out of solution (FIG. 3). By trapping gas using this approach, the plastron provides energetically favorable nucleation at the aerophilic surface and enables selective transport of the gas by capillary forces.

The CO₂ removal technology described herein can be powered by renewable resources such as wind or solar and is versatile in siting opportunities; the capture units can be located at on-shore facilities, on off-shore platforms, or on floating barges/cargo ships, whichever is most convenient (FIG. 2). The captured CO₂ can be stored under compression at the capture facility, can be fed directly to reactors for reduction to useful chemicals and fuels, can be injected directly into subsurface geologic structures, or can be fed to CO₂ lakes on the ocean floor. The CO₂ removal units can be situated near these sites and the captured gases can be injected directly, so no pipelines are needed; such storage can be provided successfully at scale for CO₂ separated from CH₄ on a platform sitting in ˜100 m of water, as at the Sleipner site in the North Sea, where >1 Mtonne/yr CO₂ has been injected since 1996 into a sand bed at 1 km depth.

The technology provided can have a significant impact on efforts to thwart the effects of accumulating fossil fuel emissions on global climate patterns, and on the aquatic environment. Specifically, our compact negative emissions technology can contribute to a reduction in the accumulated carbon loading within the oceans, and by extension, in the atmosphere, and is sufficiently versatile that it can be located on a number of platforms, both stationary and mobile. A single facility on a stationary platform can treat 50,000 m³ water/hr to remove 100 t CO₂/day, with a 3 to 4 MW power requirement, which can be provided by colocation of stationary platforms near wind farms or solar islands. Container/cargo ships retrofitted to contain the electrochemical cells and CO₂ storage tanks can be fitted with wind turbines and collected CO₂ can be discharged at stationary platforms for subsequent utilization or sequestration.

We believe that our approach is synergistic with the International Maritime Organization's (IMO's) goals to reduce CO₂ emissions and can create the economic incentives to establish a marketplace for marine decarbonization. For example, revenue can be generated at the offshore platforms for transferring the captured CO₂ from ship emissions to meet IMO goals. Furthermore, our electrochemical cells can be deployed on container/cargo ships where the captured CO₂ can be stored and transferred at the offshore platforms in return for carbon credits.

This disclosure involves the development of electrochemical cells for proton concentration modulation coupled with facile in-situ CO₂ removal to minimize disruptive bubble formation. This section describes the various steps involved in the design and fabrication of electrodes and plastrons and their integration into module fabrication.

### Selection of Electrode Materials

Electrode materials for the system should introduce protons to the seawater to enable CO₂ release when a suitable voltage is applied across the cell; these protons are then recaptured from the treated water in a second cell with a reversed cell voltage to regenerate depleted electrodes, and to alkalize the water before it is returned to the ocean. The cells work in a tandem cyclic fashion—as one set of electrodes releases protons, the second set is recharged. Some aspects can involve selected arrangements from our earlier results on proton modulation within electrochemical cells to drive the release of CO₂ from a K₂CO₃ absorbent.

We describe a number of examples of electrode pairs below, and on the basis of this disclosure those of ordinary skill can select the most suitable for a particular application, and/or other suitable electrodes not described specifically herein. Criteria for selection, depending on the specific arrangement, may include materials cost, selectivity, long-term stability, and energetics of the process per mole CO₂ removed. Representative electrode pairs to be considered initially, shown in Table 1, are based on suitable pairwise combinations of the following electrochemical half-cell reactions: (1) Protonated manganese oxide (HMnO₂) for release/capture of protons:

TABLE 1
Electrode pairs for proton modulation to enable CO₂ removal

| | HMnO₂/ | HMnO₂/ | |
|---|---|---|---|
| | AgCl | NiHCF | NiHCF/Bi |
| Electron utilization | 1 H⁺/1 | 1 H⁺/1 | 2 H⁺/3 |
| | electron | electron | electron |
| Voltage swing | 0.42 V | 0.66 V | 1.27 V |
| Estimated energy | 41 kJ/ | 64 kJ/ | 179 kJ/ |
| requirement^{a} | mol_{CO2} | mol_{CO2} | mol_{CO2} |

^{a}Estimated assuming a Faradaic efficiency of 100%

HMnO₂⇄H⁺+MnO₂+e

(2) Nickel hexacyanoferrate (NiHCF) for release/capture of Na⁺:

NiFe(CN)₆+Na⁺+e⇄NaNiFe(CN)₆

(3) Silver chloride (AgCl) for rapid and reversible reaction involving Cl⁻:

AgCl+e⇄Ag+Cl⁻

(4) Bismuth (Bi) for release of H⁺ with Cl⁻ capture:

Bi+Cl⁻+H₂O⇄BiOCl+2H⁺+3e

In the HMnO₂/AgCl system, the protonated manganese oxide (HMnO₂) and silver chloride (AgCl) electrodes will release protons and chloride ions, respectively, to acidify the seawater. The small energy requirement (41 kJ/mol_{CO2}) is an advantage of this system. In an alternative approach, nickel hexacyanoferrate (NiHCF) can be used to capture Na⁺ to counteract the HMnO₂ release of H⁺. This system has a moderate energy requirement (64 kJ/mol_{CO2}) with a low material cost. A third approach can be to release two protons at a Bi electrode as it absorbs a chloride ion, with the reaction balanced through the capture of Na⁺ by NiHCF. Other electrode materials, or combinations thereof, can also be considered, including pseudocapacitive-type systems with conductive polymers such as polypyrrole and polyaniline.

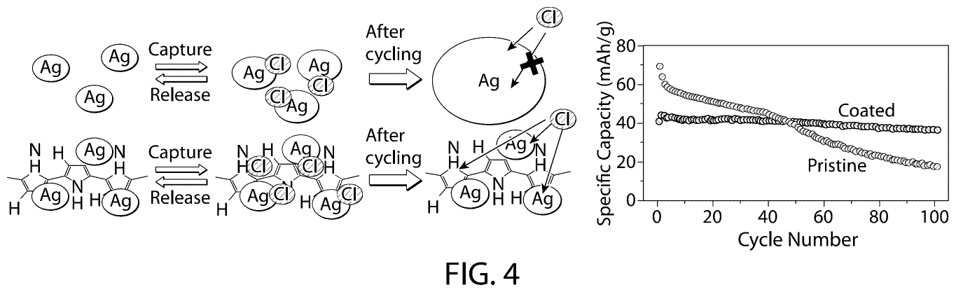

For long-term operation, stability may be considered. Mineral deposition on the electrodes under high pH conditions can provide increased electrical resistance, but these deposits will be re-dissolved when the electrode polarities are reversed. Also, the dissolution of electrode material is not likely to occur due to the low solubility constants (Kₛₚ) of components; for example, Kₛₚ=1.8×10⁻¹⁰ for silver chloride and the high Cl-concentration in seawater (530 mM) ensures dissolution will be negligible. Another concern is that agglomeration of active component nanoparticles often leads to performance fade (e.g., 70% after 100 cycles) but it has been shown that such electrodes can be stabilized by incorporating appropriate conductive polymeric materials (e.g., polypyrrole) to prevent this agglomeration and stabilize the electrode performance with less than 10% fade after 100 cycles (FIG. 4).

### Plastron Development

Through the proper design of a surface's chemistry and texture to make it superhydrophobic, a trapped air layer, called a plastron, can persist in the surface texture even when submerged into a liquid. By taking advantage of this trapped gas layer, we can capture and transport generated CO₂ gas using these aerophilic surfaces.

### Bench-Scale Module Fabrication

The electrodes and plastrons can be assembled into well-instrumented multi-stack modules for a bench-scale demonstration of the ability to remove CO₂ from sea water under multiple cycles of operation. Inkjet or screen-printing, or other technologies, can be used for fabrication of interdigitated electrodes for enhanced operation. Aerophilic surfaces can be used for CO₂ bubble capture. Integrated module(s) with electrodes and aerophilic surfaces for bench-scale demonstration of the process can be used to select specific arrangements, materials, conditions, etc.

### Modelling

A comprehensive thermodynamic model can be developed to determine possible equilibrium speciations under different conditions, and to estimate the energy requirement for electrochemical modulation of the proton concentration for CO₂ desorption. The electrochemical thermodynamic cycle can be constructed with the half-cell equilibrium potentials calculated according to the Nernst equation:

$$E = {E}_{0} + \frac{R T}{n F} ln {α}_{{H}^{+}}$$

where E₀ is the standard electrode potential for the reactions, R is the gas constant (8.314 J mol⁻¹ K⁻¹), T is the temperature (K), F is the Faraday constant (96485 C mol⁻¹), and α_{H}_{⁺}=γ_{H}+c_{H}_{⁺} is the activity, where c_{H}_{⁺} is the proton concentration, and γ_{H}_{⁺} the activity coefficient estimated using, e.g., the extended Debye-Hückel equation. This model was used previously to estimate the CO₂ capacity in K₂CO₃ as mediated by proton addition, with excellent experimental validation.

The minimum electrochemical work (Wₘᵢₙ; in kJe/molCO₂) needed to drive the reactions and desorb CO₂ can then be estimated as a function of the potential (from the Nernst equation), the solution pH and the applied current, via:

$${W}_{min} = \frac{1}{{F}_{m . C O 2}} ( {\int }_{{x}_{Cl}} {E}_{o x} dI - {\int }_{{x}_{Cl}} {E}_{red} dI )$$

where F_{m,CO2} is the molar rate of CO₂ released, and Eₒₓ and E_{red} are the oxidation and reduction equilibrium potentials, respectively. The total electrical work required for the full operation will include also energy usage associated with pumping of seawater, compression of released CO₂, and overpotentials needed to drive the process at acceptable release rates.

A transport model can be used to understand the reaction rate and behavior of the electrochemical cell, information that can assist in the overall system design and process energetics. Mass balances and charge neutrality equations are

$$ε \frac{\partial {c}_{j}}{\partial t} + ∇ \cdot ( - {D}_{i , eff} ∇ {c}_{j} - \frac{{z}_{j} F}{R T} {D}_{i , eff} {c}_{j} ∇ {φ}_{l} + u {c}_{j} ) = {S}_{j} and {\sum }_{j} {z}_{j} {c}_{j} = 0 ,$$

respectively, where ε is the volume fraction of the liquid phase, cⱼ is the concentration of species j, zⱼ is its charge, D_{i,eff} is the effective diffusivity of the species j, F is Faraday constant, φₗ is the electrolyte potential, u is the flow velocity vector, and Sⱼ is the rate of species production or consumption. For the electrochemical capture/release at the electrodes

$${s}_{j} = \frac{{v}_{j} a i}{n F} fϵ$$

for Na⁺ and Cl⁻, and

$${s}_{j} = \frac{{v}_{j} a i}{n F} fϵ$$

(conversion reaction rate to CO₂ or HCO₃⁻) for H⁺, where vⱼ is the stoichiometric coefficient, a is active surface area, i is current density, n is the number of electrons participating in the electrochemical reaction, f is faradaic efficiency, and E is electron utilization. To calculate current (i) in the system, the Butler-Volmer equation can be introduced:

$$i = {i}_{0} ( {e}^{\frac{{α}_{a} F η}{R T}} - {e}^{\frac{{α}_{c} F η}{R T}} )$$

where i₀ is the exchange current density, η is the overpotential, aa and ac are the anodic and cathodic reaction rate coefficients, respectively.

With these equations, the concentration of each species, the overpotential, and the current density distribution can be calculated to allow determination of reaction rates and energy requirements for different electrode configurations for process optimization.

### Aerophilic Concepts for CO₂ Bubble Formation Suppression.

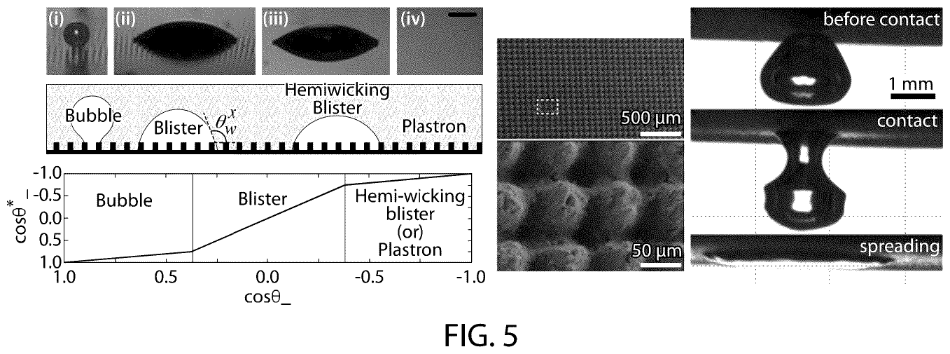

For efficient gas capture and transport, obtaining a thermodynamically stable plastron is the first design consideration for the aerophilic surfaces. The thermodynamic condition to be satisfied to ensure a stable plastron for a given surface is cos θ_{w}<−(1−ϕ)/(r−ϕ), where θ_{w} represents the equilibrium contact angle of the liquid phase on a non-textured surface, ϕ is the solid fraction of the aerophilic surface (its area wetted by the liquid when air is trapped in its texture per unit projected surface area of the solid), and r is the roughness of the aerophilic surface (its total surface area per unit project surface area of the solid). An ideal surface texture to enable the formation of a plastron should maximize roughness while minimizing its solid fraction and maintaining a large equilibrium contact angle (θ_{w}>90°). FIG. 5 shows a phase diagram of the different thermodynamic states that a gas bubble can assume on a textured surface with contact angle θ*_{w}.

For bubble capture, three parameters may be used in effective design of the aerophilic surfaces: (1) bubble capture efficiency, (2) plastron maintenance, and (3) maximum gas flow rate through this plastron. The capture efficiency generally will rely primarily on the timescale for a bubble to be captured by the plastron and can be estimated using a hydrodynamic drainage model where the drainage time, t_{d}, for a bubble of diameter D_{b} to displace an electrolyte of viscosity μ is t_{d}˜(μD_{b}²)/(Pₚ hₚ²), where Pₚ and hₚ are the pressure and thickness, respectively, of the plastron layer.

### Electrode Fabrication

HMnO₂ and NiHCF nanoparticles can be prepared by a simple coprecipitation method. Commercial powders can be employed as active materials for the AgCl and BiOCl electrodes. Incorporation of, e.g., polypyrrole or ruthenium, within these materials can be by traditional chemical deposition methods, including by electrodeposition. The electrodes can be prepared by mixing these active materials with conducting agents (e.g., CNTs, carbon black particles) and polymeric binders in an organic solvent. For initial screening experiments and materials characterization, the resulting inks can be deposited on conductive substrate swatches (1 cm×1 cm) by dip-coating to be used in screening two- and three-electrode tests. Typical active material loading will be 50 g/m² electrode area. Subsequently, the inks can be applied to a non-conductive substrate by inkjet or screen-printing of the anode and cathode electroactive conductive materials in an interdigitated format, as illustrated schematically in FIG. 3, which can provide lower ionic resistance between the two electrodes than in the separated electrode system and can allow for easier bubble disengagement and removal. Specifically, each interdigitated electrode can consist of a conductive base layer, with conductive particles such as, e.g., silver nanoparticles (AgNP) and/or carbon nanotubes (CNT), upon which will be deposited the electrochemically active layer. Inkjet printing is a relatively inexpensive method to deposit small droplets with high resolution, allowing for precise placement of many types of materials. From our preliminary experience with inkjet printing of electrodes, the primary risk is clogging of the printheads by unstable inks, which will be overcome by optimization of the ink formulation.

Module Fabrication with CO₂ Bubble Capture

We fabricate gas capture modules using planar sheets of aerophilic gas capture surfaces. Electrodes will be located within the flow channel, as shown in FIG. 1 and FIG. 2, while the lateral walls of the flow channel will be comprised of the gas capture sheets. Fabrication of aerophilic surfaces for experiments will be done in two stages. First, aerophilic surfaces made from silicon may be made using standard lithographic techniques in a clean room to precisely control surface morphology and empirically confirm our models. Second, surfaces may be manufactured using scalable texturing approaches such as sprays, printing, self-assembly, phase transformations, and laser ablation to fabricate large area optimal surface textures such as the pyramidal “low-phi” surfaces. These are well-established procedures with little risk.

### Bench-Scale Demonstration

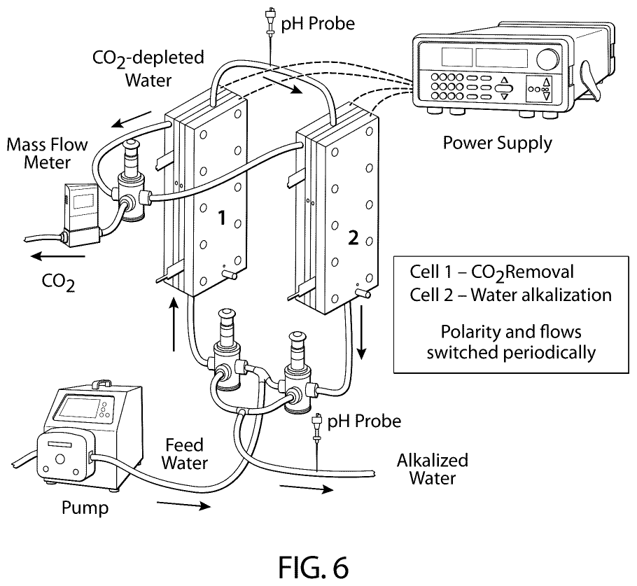

The modules themselves can include, e.g., between one and ten electrode-plastron-gas channel combination cells of nominal dimension 2 cm×10 cm sandwiched between acrylic end plates. Two modules can be used, as illustrated in FIG. 6, the first in which the feed stream is protonated, and the other in which the CO₂-depleted stream is alkalized. The bench-scale system can be set up with appropriate pumps, power sources, mass flow controllers, CO₂ analyzers and pH probes, all operating under LabView control. Timely switching of the flows and voltages in the two modules can be used to ensure stable cyclic operation. Long-term operation can be deemed successful if the cyclic performance shows <5% decline in CO₂ removal efficiency over 100 hrs continual operation.

### Characterization

### Material Characterization

Fundamental characterization of electrode materials can be carried out by X-ray diffractometry (XRD), and X-ray photoelectron spectroscopy (XPS) to investigate their crystal structures and chemical states. The morphology and pore distribution of the electrodes can be analyzed by scanning electron (SEM) and transmission electron (TEM) microscopy, and by Brunauer-Emmett-Teller (BET) analysis.

### System Performance (Including Electrochemical Characterization)

The electrochemical system performance can be assessed at both the individual compartment and the process level. For the individual compartments (e.g., electrode and electrolyte) various techniques can be implemented including cyclic voltammetry and electrochemical impedance spectroscopy. For the process level evaluation, long-term potential-voltage profiles as well as the cyclic CO₂ capacity can be carefully monitored.

### Stability Measurement

The stability of the system can be evaluated in two respects: (i) performance under repeated cycles (initial target is less than 5% fade in performance over 10,000 cycles), and (ii) possible dissolution of the electrodes (acceptable loss during this development stage can be less than 1% per 10 m³ water treated). The electrochemical capacity, pH and DIC (dissolved inorganic carbon) concentration of the effluent can be monitored over a large number of operation cycles to evaluate the stability of the system. In addition, physicochemical characteristics of the electrodes would also be investigated by various materials characterization tools (e.g. XRD, XPS, and SEM) in order to detect any electrode material transformations that may occur during the long-term operations. To verify that there are no metal ions in the water following the electrochemical process for CO₂ removal, the concentration of metals (e.g. Mn, Ag, Bi, Ni, Fe, etc.) in the treated water can be measured by ICP-MS.

### Aerophilic Surface Characterization

Capture efficiency can be validated experimentally using high-speed imagery. Mass flow metering and optical imagery can be used to characterize the dynamic stability of the surfaces and validate maximum achievable gas flow rates. Plastron stability can be validated using standard goniometry techniques to measure contact angles. These characterizations can result in a phase diagram for the bubble capture efficiency and maximum gas flow rates, while maintaining a thermodynamically favorable plastron.

A number of processes can be employed for the formation of electrode systems and configurations, along with their fabrication technologies. Useful components can include wet benches and hoods, and appropriate small equipment for chemical synthesis and handling, as well as assorted equipment for analytical purposes (HPLC, UV-Vis, GC-MS, potentiostats, etc.). Additionally, optionally TEM, SEM, XPS, XRD, ICP-OES, etc. for detailed characterization of electrodes and system performance.

Numerous approaches can be used for surface modification for various applications including bubble capture and transport. The following imaging capabilities can be useful: multiple microscopes (10,000× mag), high-speed cameras (1 million frame per second), high-speed infrared camera, high-intensity light sources and navitar high-magnification camera lenses. Wetting characterization tools including goniometry, tensiometry, and electrochemical bubble setups to study bubble formation and/or to measure reaction productivity. Potentiostat/galvanostat systems can be used to control/measure electrochemical characteristics, while pH can be measured using dyes or a variety of pH probes.

TABLE 3
Technology and performance metrics

| Electrode Assembly | | | Operation | | Costs | |
|---|---|---|---|---|---|---|
| Active material | 50 g/m² | | Electron | 0.8-1 | Levelized cost | <$100/ton |
| loading | electrode area | | utilization | electron/CO₂ | of capture | (target) |
| Proton capacity | 3 mol H⁺/kg | | Performance | <5% over | Capital cost | $100-500K*/ |
| | active material | | fade | 10,000 cycles | 1 t CO₂/day | (tCO₂/day) |
| Electrode thickness | 200 | μm | Electrical energy | <100 kJ/mol | Second law | >10% |
| | | | | CO₂ | efficiency | |
| Plastron thickness | 10 | μm | Feed CO₂ | 2.5 mol/m³ | Embodied | <5% |
| | | | | | emissions | |
| Gas channel thickness | 5 | mm | CO₂ removal | 80% | Water/chemical | None |
| | | | | | consumption | |
| Liquid flow channel | 5 | mm | Initial/Final pH | 8.1/8.3 | | |
| Area per unit volume | 100 | m²/m³ | Final CO₂Gas | 25° C./1 | | |
| | | | T/P/Impurities | bar/<1% water | | |

Those of ordinary skill in the art can design appropriate systems and structures in view of the present disclosure. For example, the unit size to remove e.g. at least 1 ton CO₂/day (400 m³) with a cycle time of less than or equal to 1 hr is based on an electrode proton storage capacity of 3 mol H⁺/kg active material, and a total active material loading per unit electrode area of 0.05 kg/m². A typical electrode area can be 100 m²/m³ cell volume. Units can be located on existing platforms, ships, etc., and that the storage sites have already been developed. Electricity consumption can be calculated from the electrochemical properties of the electrodes, allowing for appropriate overpotentials and resistive losses, in addition to pumping and compression requirements.

Our approach is to provide technology that can address both the fundamental bottlenecks for direct ocean capture while being practical and scalable for industrial deployment. We can develop system design and performance regime maps and build a proof-of-product prototype using scalable manufacturing techniques. Our work on fabrication using inkjet printing and spray coating can reduce the risk on scale-up and manufacturing as there already exists an install base of such manufacturing facilities and well-established supply chains.

We can use our expertise from our existing work on electrochemically modulated selective chemical separations and on gasphilic surface, super slippery surfaces and scalable surface fabrication approaches.

### Example 2

Industrial emissions of carbon dioxide and other gases are wreaking havoc on the environment as the continuing accumulation of CO₂ in the atmosphere leads to rising temperatures and disruption of the global climate patterns. There has been a surge of interest in negative emissions technologies in which CO₂ is removed from the ambient environment itself through approaches such as direct air capture (DAC), bioenergy with carbon capture and sequestration (BECCS), and reforestation. The focus on atmospheric accumulation has not yet been matched by a similar drive to reduce CO₂ in oceans and other surface waters, however, where increasing acidification has already led to destruction of coral reefs, and reduced carbonate ion concentrations harm shellfish and other marine life. The total amount of CO₂ in the ocean rivals that in the atmosphere, and thus effective means for its removal can augment the other negative emissions technologies to reduce the environmental burden imposed by this greenhouse gas. Moreover, while direct air capture requires both capture of the CO₂ by chemical complexation with a sorbent, and subsequent breaking of these bonds when the CO₂ is recovered as a pure gas, only the latter step is needed for CO₂ removal from surface waters, which avoids one of the steps usually required for CO₂ mitigation from gaseous sources. The CO₂ can be released as a pure gas stream, which can be stored in geologic formations, or can be recovered as precipitated calcium carbonate which can be deposited on the ocean bed, or used in a range of different applications, among which construction materials would be the largest; the production of carbonates is the focus of this work.

Approaches to solving this challenging problem need to be identified that do not require addition of chemicals, nor lead to parasitic reactions with the formation of undesirable compounds. The ONR, in perhaps the most advanced developments to date, has shown that electro-deionization can be an effective means to address these problem, but the need for ion-exchange membranes and special anolyte and catholyte solutions makes this an expensive proposition. We provide a new membrane-free approach based solely on electrochemical alkalization of the sea water to sufficiently high pH to precipitate the carbonate, and then subsequent adjustment of the pH of the treated water before it is returned to the ocean. This electro-swing approach does not require expensive membranes or addition of chemicals, is easy to deploy, and does not lead to formation of byproducts or secondary streams. We provide electrode configurations that can reduce overall transport and electrical resistances while enabling treatment of large quantities of water. We provide effective ways to initiate particle nucleation and growth in a controlled manner, and capture and remove the precipitates as they form. In contrast to the growing number of papers addressing the direct capture of CO₂ from ambient air, only a handful of reports have been published on the removal of CO₂ from ocean waters, and these have been based on either classical electrodialysis. Some studies have describe a process wherein protons generated in an anode chamber pass through a cation exchange membrane to a central compartment in which the pH of the feed seawater is reduced to release CO₂, which can be vacuum stripped. The sodium ions displaced by these protons pass through a second cation exchange membrane to report to the cathode chamber, where water splitting occurs to produce hydrogen gas and sodium hydroxide; the NaOH is mixed with the effluent from the center chamber to alkalize the CO₂-depleted feed stream before it is returned to the ocean, or to drive the mineralization to form CaCO₃. The process achieved its stated goal of producing hydrogen gas while simultaneously removing CO₂ from the ocean water; the NaOH produced was then used to basify the treated ocean water. While no chemical reagents were needed, there was a need for deionized water obtained via reverse osmosis to be introduced to both electrode chambers (about 20% of the flow of seawater), which provided added process complexity.

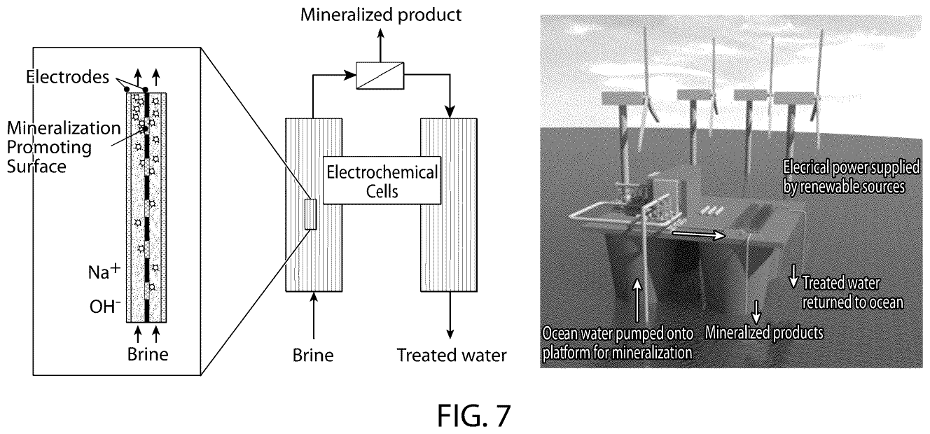

The general principles of electrochemically modulated carbonate formation from brines are illustrated schematically in FIG. 7. The brine to be treated is fed to the first electrochemical cell where a suitable voltage is applied to enable pH adjustment to a high level (pH˜9.5) to drive the carbonate formation through the release of hydroxyls from metal hydroxide electrodes (alternatively, the adsorption of protons by intercalation in metal oxide electrodes can be used to adjust the pH). The opposite electrode can modulate counterion concentrations to ensure solution electrical neutrality. This pH-modulation is achieved without the loss of electron efficiency that would be incurred with the parasitic production of gases during normal water electrolysis as in electro-dialysis or electro-deionization and does not require the use of separate anolyte and catholyte solutions. The precipitated carbonate particles are removed from the solution through gravitational settling, centrifugation, or filtration. Subsequently, the solution is introduced to the second electrochemical cell where the electrodes are regenerated on application of a voltage of reverse polarity and the pH is returned to approximately its starting value; during this process some of the energy expended in the metal carbonate formation is recovered to reduce the overall energetics of the process. The solution is then returned to the brine or disposed of in other ways. This can be a cyclic process in which once the electrodes are depleted of hydroxyls the flows and polarities are switched such that the second cell is used for carbonate formation and the first cell is regenerated.

Nanoengineered surfaces can be incorporated in the cell assembly to enhance the rates of mineralization and drive the precipitation of preferred carbonates from complex solutions.

### Electrochemical Modulation of pH

For proton removal, metal oxides that capture or release protons can be used. Electrochemical pH swing in aqueous solution has recently been shown to be an effective means for the mediation of the capture and release of CO₂ in the promoted potassium carbonate (K₂CO₃) process. Under a suitable applied voltage across the cell, protons are captured by manganese oxide (MnO₂) electrodes, the solution is alkalized, and the CO₂ is converted to carbonate ions. The proton capture proceeds by the reaction MnO₂+H⁺+e⇄HMnO₂, with an estimated theoretical capacity of 11.5 mmol H⁺/g. Since seawater contains 2.5 mmol HCO₃, −500 mg of MnO₂ is necessary to treat 1 L of seawater (on the assumption of 50% MnO₂ utilization in proton capture) in one cycle. Other oxides, such as ruthenium oxide (RuO₂) and titanium oxide (TiO₂), which have been explored as proton intercalating materials in pseudocapacitors, can also be considered. The use of bismuth electrodes is another option, as these can both capture protons from, and release chloride ions to, oceanwater (BiOCl+2H⁺+3e⇄Bi+Cl⁻+H₂O) (with capacity 3.19 mmol H⁺/g.

Alkalization can also be attained through the reversible release of hydroxyls from metal hydroxides on application of an appropriate voltage, (e.g., Ni(OH)₂+OH⇄NiOOH+H₂O+e) in alkaline solution (with 10.8 mmol H⁺/g theoretical capacity). Long-term stability of the electrodes can be ensured, if desired, by coating them with appropriate ion-exchange polymeric layers.

Counter electrodes with storage capacity for counterions are necessary to avoid parasitic loss of current efficiency (e.g., water splitting reactions). Na⁺-capturing electrodes (e.g. nickel hexacyanoferrate: NiFe(CN)₆+Na⁺+e⇄NaNiFe(CN)₆) and Cl⁻-capturing electrodes (e.g. silver: Ag+Cl⁻⇄AgCl+e) can be used to compensate for the charges in solution associated with the proton sorption or hydroxide release.

### Nanoengineered Surfaces for Enhanced & Preferential Mineralization of CaCO₃

Some factors can be addressed in precipitating carbonate using our electrochemical approach include: (1) preventing crystal formation on electrode surfaces as this can lead to passivation (2) enhancing nucleation and growth rates of the crystallization process to enhance the overall efficiency of the system (3) removal of carbonate crystals from the reactor.

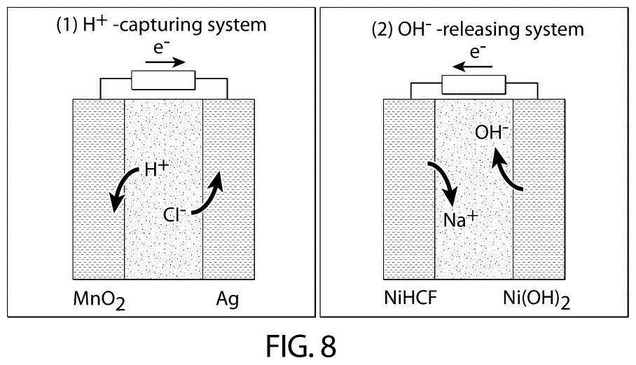

We address the above challenges by developing nanoengineered surfaces with optimal surface morphology and chemistry that can enhance nucleation and growth and cause preferential crystallization on them away from the electrode surfaces (FIG. 3a). These surfaces can be introduced proximal to the cathode to take advantage of increased local pH. We can develop these surfaces using our expertise in crystallization and interfacial science. The free energy barrier ΔG and the nucleation rate J for heterogeneous nucleation depends on interfacial energies and lattice mismatch, and are given by:

$$Δ G = \frac{π {σ}_{cv} {r}^{* 2} ( 2 - 3 m + {m}^{3} )}{3 {( 1 + C {r}^{*} {ε}^{2} / 2 {σ}_{c v} )}^{2}} ; J = {J}_{o} exp ( - Δ G / kT )$$

where σ_{cv} is the condensed phase interfacial energy and r* is the critical radius. The parameter m=(σₛᵥ−σ_{sc})/σ_{cv} is the ratio of the interfacial energies (σₛᵥ, σ_{sc}, are the substrate-vapor and substrate-condensed phase interfacial energies respectively), ε is the lattice mismatch, k is the Boltzmann constant, and Jₒ is a kinetic constant. Hence, we develop surfaces with optimal surface energies and polarity as well as morphology length scales (schematic in FIG. 8) to enhance mineralization.

### Surface Chemistry

Our approach to designing the appropriate surface chemistry involves independently controlling the Lifshitz-Van der Waals component (γ^{LW}) and the polar acid (γ⁺)-base (γ) electron-exchange components based on our expertise and a catalogue of surface chemistries that we have developed over past several years. These components can be used to characterize surface interactions that lead to precipitation, and this understanding beyond contact angles and lumped measures of surface energy allows us to identify the key components of surface chemistry for surface design. For example, we demonstrate preferential nucleation by designing hybrid surface energy materials (FIG. 8). We lower carbonate nucleation energy barriers by coating functional groups that play an important role in marine biomineralization such as —CO₂, —OH, —SO₃⁻, —CH₃).

### Surface Morphology

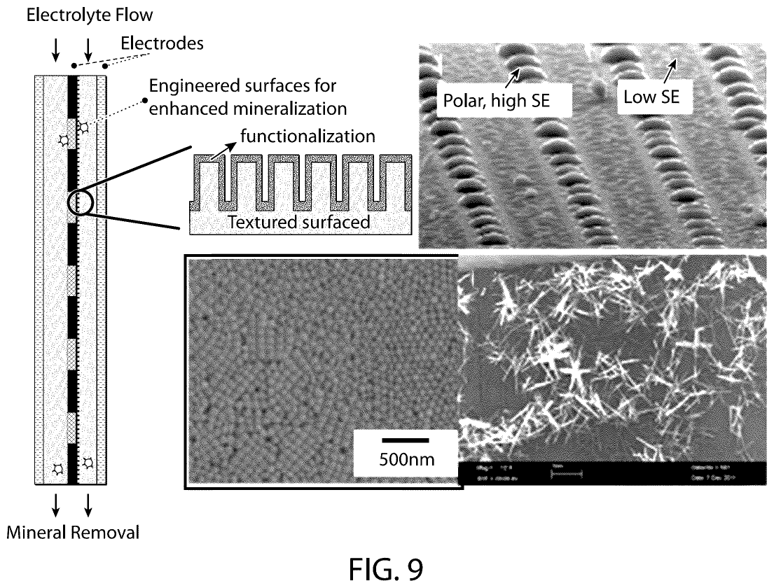

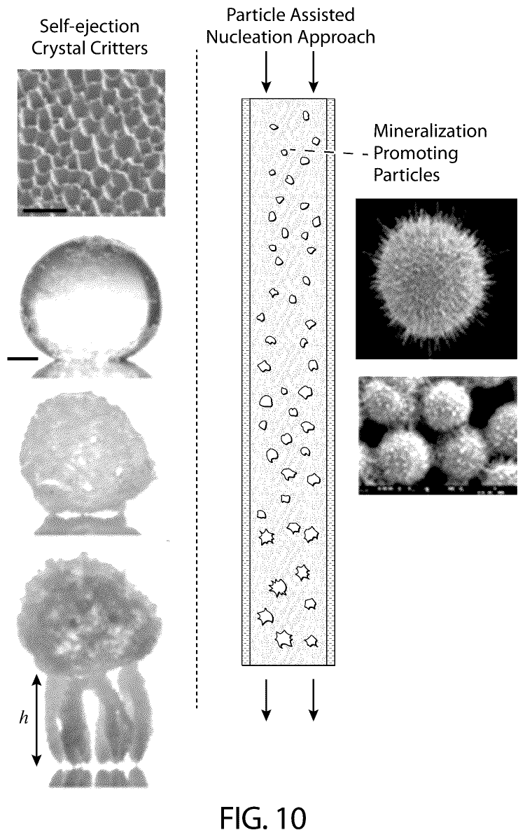

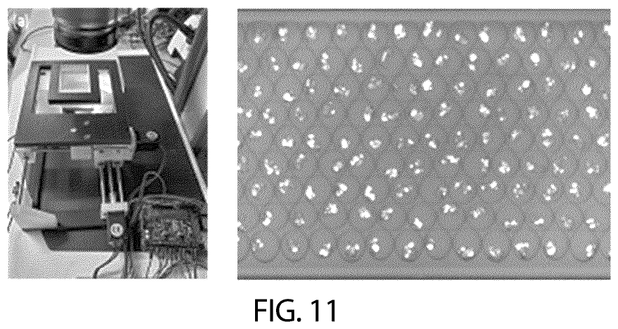

Another parameter that controls crystallization is surface texture. By designing surface texture at ˜1-10-fold length scales of the nucleation radius r*, we can significantly boost nucleation rates and control crystal polymorphs by promoting nanoscale confinement effects. Previous work had shown significant an increase in nucleation rates for minerals FIG. 8 as well as complex systems such as protein crystals FIG. 10 even under bulk undersaturated conditions. We have over the years developed many nanoscale texturing approaches for both surfaces and particles and can accordingly utilize these approaches for designing the appropriate textures. Finally, precipitate removal from surfaces can be engineered using our recently discovered “crystal critter effect” where confinement leads to out-of-plane crystal growth and results in the self-ejection of mineralized deposits from the surfaces to continually renew the nucleation surface FIG. 9. In another embodiment, multiscale particles with the surface chemistry and texture obtained above can be introduced to seed nucleation in the bulk and the precipitated minerals are removed by flow or settle under gravity (FIG. 9).

### Workplan

The work plan may consist of thermodynamic and transport modeling for effective module design and process evaluation, electrode preparation and characterization for initial testing of concepts in a batch system mineralization surface preparation and characterization fabrication of integrated module with electrodes and/or mineralization surfaces for bench-scale demonstration of the process.

### Thermodynamic and Transport Modeling

A comprehensive thermodynamic model can be developed to predict equilibrium speciation under different conditions, and to estimate the energy requirement for electrochemical modulation of the proton concentration for CO₂ desorption. The electrochemical thermodynamic cycle can be constructed with the half-cell equilibrium potentials determined by the Nernst equation:

$$E = {E}_{0} + \frac{R T}{n F} ln {α}_{{H}^{+}}$$

where E₀ is the standard electrode potential for the reactions, R is the gas constant (8.314 J mol⁻¹ K⁻¹), T is the temperature (K), F is the Faraday constant (96485 C mol⁻¹), and α_{H}_{⁺}=γ_{H}_{⁺}c_{H}_{⁺} is the activity, where c_{H}_{⁺} is the proton concentration, and γ_{H}_{⁺} the activity coefficient estimated using, e.g., the extended Debye-Hückel equation. This model was used previously to estimate the CO₂ capacity in K₂CO₃ as mediated by proton addition, with excellent experimental validation.

The minimum electrochemical work (Wₘᵢₙ; in kJe/molCO₂) needed to drive the reactions can then be estimated as a function of the potential, solution pH and applied current, via:

$${W}_{min} = \frac{1}{{F}_{m . C O 2}} ( {\int }_{{x}_{Cl}} {E}_{o x} dI - {\int }_{{x}_{Cl}} {E}_{red} dI )$$

where F_{m,CO2} is the molar rate of CO₂ mineralization, and Eₒₓ and E_{red} are the oxidation and reduction equilibrium potentials, respectively. The total electrical work required for the full operation can include also energy usage associated with pumping of seawater, separation of precipitated carbonates, and overpotentials needed to drive the process at acceptable production rates.

A transport model for the prediction of reaction rate and behavior of the electrochemical cell can be developed to predict species concentration distributions, overpotentials and current densities, information that can drive completion of the overall system design and provide estimates of the process energetics. Mass balances and charge neutrality equations are

$$ε \frac{\partial {c}_{j}}{\partial t} + ∇ \cdot ( - {D}_{i , eff} ∇ {c}_{j} - \frac{{z}_{j} F}{R T} {D}_{i , eff} {c}_{j} ∇ {φ}_{l} + u {c}_{j} ) = {S}_{j} and {\sum }_{j} {z}_{j} {c}_{j} = 0 ,$$

respectively, where E is the volume fraction of the liquid phase, cⱼ is the concentration of species j, zⱼ is its charge, D_{i,eff} is the effective diffusivity of the species j, F is Faraday constant, φₗ is the electrolyte potential, u is the flow velocity vector, and Sⱼ is the rate of species production or consumption. To calculate current (i) in the system, the Butler-Volmer equation can be introduced:

$$i = {i}_{0} ( {e}^{\frac{{α}_{a} F η}{R T}} - {e}^{\frac{{α}_{c} F η}{R T}} )$$

where i₀ is the exchange current density, η is the overpotential, αₛ and α_{c} are the anodic and cathodic reaction rate coefficients, respectively.

### Electrode Fabrication and Characterization

Metal oxides and nickel hexacyanoferrate particles can be prepared by a coprecipitation method. For chloride-capturing electrodes, commercial powders can be employed as active materials. Metal hydroxides for hydroxide ion capture/release can be prepared by electrodeposition using metal salts in the solution. The electrodes can be prepared by mixing these active materials with conducting agents (e.g., CNTs, carbon black particles) and polymeric binders in an organic solvent. For initial screening experiments and materials characterization, the resulting inks can be deposited on conductive substrate swatches (2 cm×2 cm) to be used in screening two- and three-electrode tests.

Fundamental characterization of electrode materials can be carried out by X-ray diffractometry (XRD), and X-ray photoelectron spectroscopy (XPS) to investigate their crystal structures and chemical states. The morphology and pore distribution of the electrodes can be analyzed by scanning electron (SEM) and transmission electron (TEM) microscopy, and by Brunauer-Emmett-Teller (BET) analysis. The electrochemical system performance can be assessed at both the individual compartment and the process level. For the individual compartments (e.g., electrode and electrolyte) various techniques can be implemented including cyclic voltammetry and electrochemical impedance spectroscopy. For the process level evaluation, long-term potential-voltage profiles and pH modulation can be carefully monitored.

### Mineralization Surface Plan

We conduct experiments in two steps: coarse and fine, where the coarse experiments can help down select the conditions for the finer high throughput experiments. The first set of experiments can be the systematic set of tests varying substrate surface energy and morphology at different supersaturation and pH levels. Substrate coupons can be completely submerged in the solution. Carbonate formation can be tracked by (1) pH measurements, (2) turbidity, and (3) zeta potential (Zetasizer) with time. The solution pH can show kinetics of calcite formation (pH drops as carbonate forms) and allows calculation of induction time, nucleation rate, and growth rate. Turbidity and zeta potential measurements can give an indication of bulk (homogeneous) calcite formation, allowing estimation of surface-specific kinetics. For example, if the time at which PH begins to drop corresponds to detection of nanocrystals using the zetasizer, we know that calcite formation is occurring in the bulk. If the pH drops without any associated bulk formation, we can be confident that the kinetics describe surface precipitation. Following complete precipitation, the mass of crystal precipitants on the surface can be measured, and SEM images can be taken of the resulting crystals, Given that the nucleation-growth process is highly stochastic, we can utilize our high throughput microfluidic droplet reactors to provide statistically significant values for the nucleation parameters (FIG. 10). For example, we have utilized such an approach in the past for protein crystallization.

We can use machine learning tools to track the nucleation rates from the microscopic images. These can provide us the phase diagram for optimal CaCO₃ precipitation. Next, we can combine the electrochemical and mineralization designs to demonstrate the process in-situ.

We are confident that characterization of surface chemistry, morphologies, and pH that maximize CaCO₃ precipitation into a phase diagram can enable our electrochemical reactor design even within non-ideal solutions; which has clear importance in ocean water treatment where temperatures and compositions are constantly changing. We can then develop a bench scale reactor that incorporates the learnings from the above approaches to simulate scale-up ad plant conditions (for example mixing and shear). These phase diagrams can be used to develop and bench-scale reactor that can demonstrate the ability to scale and serve as a proof-of-product.

### Bench-Scale Demonstration

The modules themselves can consist of between one and ten electrode cells of nominal dimension 2 cm×10 cm sandwiched between acrylic end plates. Two modules can be used in tandem, the first in which the feed stream is alkalized to induce metal carbonation, and the other in which the pH of the CO₂-depleted stream is adjusted back to the nominal pH of the ocean water, and formerly depleted electrodes are regenerated. The bench-scale system can be set up with appropriate pumps, power sources, mass flow controllers, and pH probes, all operating under LabView control. Timely switching of the flows and voltages in the two modules can be used to ensure stable cyclic operation.

Other Opportunities for Electrochemically Modulated Mineralization of CO₂—Li₂CO₃ Production

The technology for the removal of CO₂ from ocean water as calcium carbonate precipitates can be exploited in another area of significant interest to the energy sector. For instance, a major source of Li is lithium-rich brines, from which Li is recovered by sequential evaporation and precipitation. Lithium carbonate (Li₂CO₃) is the most common tradable lithium product and is usually obtained by adding a large amount of sodium carbonate to the LiCl-containing brine to precipitate it. Instead of using Na₂CO₃, CO₂ can be used as the carbonate source, which, in an electrochemically modulated alkalized brine solution, precipitates the desired lithium carbonate product.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system, comprising:
a fluid container;
an electrode pair configured to convert at least one species in a fluid, when present in the container, to a solid; and
a nanotextured surface configured to facilitate nucleation of a solid within the container.

2. The system of claim 1, wherein the solid comprises a carbonate-containing compound.

3. A system, comprising:
a first fluid portal associated with a first portion of the flow system and a second fluid portal associated with a second portion of the flow system;
a first set of electrodes associated with the first portion of the flow system, configured to alter the pH of water when present in the first portion;
a second set of electrodes associated with a second portion of the flow system, configured to alter the pH of water when present in the second portion;
a nanotextured surface configured to facilitate nucleation of a solid within the container,
wherein the flow system is configured to operate in a first arrangement in which the system draws fluid into the system from the first fluid portal, flows the fluid in a direction from the first portal toward the second portal, through the first portion and the second portion, and ejects the fluid from the second fluid portal, and to be adjustable so as to operate in a second arrangement in which the system draws fluid into the system from the second fluid portal, flows the fluid in a direction from the second portal toward the first portal, through the second portion and the first portion, and ejects the fluid from the first fluid portal.

4-6. (canceled)

7. A method, comprising:
intaking an aqueous solution containing bicarbonate through a first orifice into a flow system;
in a first portion of the flow system, electrochemically raising the pH of the solution by releasing OH⁻ from a first electrode into the solution, and/or capturing H⁺ from the solution at the first electrode, thereby causing precipitation of at least some bicarbonate;
flowing the solution into a second portion of the flow system, and at a second electrode electrochemically lowering the pH of the solution by capturing OH⁻ from the solution at a second electrode and/or releasing H⁺ into the solution from the second electrode;
ejecting the solution from the flow system through a second orifice.

8. The method as in claim 7, further comprising:
intaking an aqueous solution containing bicarbonate through the second orifice into the flow system;
in the second portion of the flow system, electrochemically raising the pH of the solution by releasing OH⁻ from the second electrode into the solution, and/or capturing H⁺ from the solution at the second electrode, thereby causing precipitation of at least some bicarbonate;
flowing the solution into the first portion of the flow system, and at the first electrode electrochemically lowering the pH of the solution by capturing OH⁻ from the solution at the first electrode and/or releasing H⁺ into the solution from the first electrode;
ejecting the solution from the flow system through the first orifice.

9. The method of claim 7, wherein at least some bicarbonate is removed from the solution, facilitated by nucleating at least some bicarbonate at a surface, wherein the surface optionally is a surface of a nanotextured surface.

10. The method of claim 7, wherein the gas permeable article is water impermeable and is not ionically nor electronically conductive.

11. The method as in claim 7, wherein the flow system is essentially free of anolyte and catholyte.

12. The method as in claim 7, wherein the method is free of electrolysis.

13. The method as in claim 7, wherein the solution is seawater.

14. The system claim 1, wherein the gas permeable article is permeable to carbon dioxide.

15. The system of claim 1, wherein the nanotextured surface is configured to facilitate nucleation of carbon dioxide.

16. The method of claim 7, wherein lowering the pH comprises lowering the pH from a first pH to a second pH, wherein the second pH is lower than the first pH.

17. The method of claim 7, wherein raising the pH comprises raising the pH from a first pH to a second pH, wherein the second pH is greater than the first pH.
